(19) United States
(12) Patent Application Publication
(10) Pub. No.: US 2025/0096865 A1
(43) Pub. Date: Mar. 20, 2025

(54) TECHNIQUES FOR CHANNEL STATE INFORMATION REPORTING IN FULL-DUPLEX COMMUNICATION MODES

(71) Applicant: QUALCOMM Incorporated, San Diego, CA (US)

(72) Inventors: Qian ZHANG, Basking Ridge, NJ (US); Yan ZHOU, San Diego, CA (US); Tao LUO, San Diego, CA (US)

(21) Appl. No.: 18/468,614

(22) Filed: Sep. 15, 2023

(51) Int. Cl. H04B 7/06; H04B 17/318; H04B 17/336; H04L 5/14

(52) U.S. Cl. CPC H04B 7/0626; H04B 17/328; H04B 17/336; H04L 5/14

(57) ABSTRACT

Methods, systems, and devices for wireless communication are described. In some examples, a user equipment (UE) may receive control information from a network entity that includes a configuration for self-interference channel state information (CSI) measurements and self-interference CSI reporting. The control information may additionally include configurations for interference measurements other than self-interference. The UE may perform one or more self-interference CSI measurements and other CSI measurements based on receiving the control information. In some examples, the one or more self-interference CSI measurements may be associated with one or more subbands based on the configuration for self-interference CSI measurements. The UE may transmit one or more CSI reports, including one or more CSI reports associated with self-interference, to a network entity based on performing the one or more CSI measurements.

### FIELD OF TECHNOLOGY

The following relates to wireless communication, including techniques for channel state information (CSI) reporting in full-duplex communication modes.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for channel state information (CSI) reporting in full-duplex communication modes. For example, the described techniques enable a user equipment (UE) (e.g., a full-duplex UE) to perform CSI measurements for self-interference and to transmit CSI reports that are associated with self-interference. In some examples, a UE may receive control information from a network entity that includes a configuration for self-interference CSI measurements. The control information may additionally include configurations for interference measurements other than self-interference. The UE may perform one or more CSI measurements, including CSI measurements for self-interference, based on receiving the control information. In some examples, one or more CSI measurements for a UE (e.g., for a subband full-duplex (SBFD) capable UE) may be associated with one or more subbands. For example, the UE may perform one or more self-interference CSI measurements in a subband (e.g., a downlink subband, an uplink subband) based on receiving the configuration for self-interference CSI measurements. The UE may transmit one or more CSI reports, including one or more CSI reports associated with self-interference, to a network entity based on performing the one or more self-interference CSI measurements.

A method for wireless communication by a UE is described. The method may include receiving control information that includes a first configuration for a first CSI measurement and a second configuration for a second CSI measurement, where the first CSI measurement is associated with self-interference from full-duplex communications of the UE and the second CSI measurement is associated with a channel measurement and interference measurements other than self-interference of the UE, performing the first CSI measurement and the second CSI measurement, where the first CSI measurement is performed in accordance with the first configuration and the second CSI measurement is performed in accordance with the second configuration, and transmitting, based on the performing, a CSI report including one or more first CSI metrics, where each CSI metric of the one or more first CSI metrics is associated with both of the first CSI measurement and the second CSI measurement.

A UE for wireless communication is described. The UE may include one or more memories storing processor executable code, and one or more processors coupled with the one or more memories. The one or more processors may individually or collectively operable to execute the code to cause the UE to receive control information that includes a first configuration for a first CSI measurement and a second configuration for a second CSI measurement, where the first CSI measurement is associated with self-interference from full-duplex communications of the UE and the second CSI measurement is associated with a channel measurement and interference measurements other than self-interference of the UE, perform the first CSI measurement and the second CSI measurement, where the first CSI measurement is performed in accordance with the first configuration and the second CSI measurement is performed in accordance with the second configuration, and transmit, based on the performing, a CSI report including one or more first CSI metrics, where each CSI metric of the one or more first CSI metrics is associated with both of the first CSI measurement and the second CSI measurement.

Another UE for wireless communication is described. The UE may include means for receiving control information that includes a first configuration for a first CSI measurement and a second configuration for a second CSI measurement, where the first CSI measurement is associated with self-interference from full-duplex communications of the UE and the second CSI measurement is associated with a channel measurement and interference measurements other than self-interference of the UE, means for performing the first CSI measurement and the second CSI measurement, where the first CSI measurement is performed in accordance with the first configuration and the second CSI measurement is performed in accordance with the second configuration, and means for transmitting, based on the performing, a CSI report including one or more first CSI metrics, where each CSI metric of the one or more first CSI metrics is associated with both of the first CSI measurement and the second CSI measurement.

A non-transitory computer-readable medium storing code for wireless communication is described. The code may include instructions executable by a processor to receive control information that includes a first configuration for a first CSI measurement and a second configuration for a second CSI measurement, where the first CSI measurement is associated with self-interference from full-duplex communications of the UE and the second CSI measurement is associated with a channel measurement and interference measurements other than self-interference of the UE, perform the first CSI measurement and the second CSI measurement, where the first CSI measurement is performed in accordance with the first configuration and the second CSI measurement is performed in accordance with the second configuration, and transmit, based on the performing, a CSI report including one or more first CSI metrics, where each CSI metric of the one or more first CSI metrics is associated with both of the first CSI measurement and the second CSI measurement.

Some examples of the method, UEs, and non-transitory computer-readable medium described herein may further include operations, features, means, or instructions for receiving an indication of one or more resources for the first CSI measurement via a field of the control information that may be associated with self-interference.

Some examples of the method, UEs, and non-transitory computer-readable medium described herein may further include operations, features, means, or instructions for receiving an indication of one or more first resources for a sounding reference signal measurement via a first field of the control information, an indication of one or more second resources for a received signal strength indicator (RSSI) measurement via a second field of the control information, or both, where the first field and the second field may be associated with the first configuration.

In some examples of the method, UEs, and non-transitory computer-readable medium described herein, the one or more first CSI metrics may be associated with self-interference, a channel measurement, and one or more of inter-cell interference, multiple user multiple input multiple output (MU-MIMO) interference, and cross link interference (CLI).

In some examples of the method, UEs, and non-transitory computer-readable medium described herein, the one or more first CSI metrics may be associated with an identifier that indicates that the one or more first CSI metrics may be associated with self-interference.

Some examples of the method, UEs, and non-transitory computer-readable medium described herein may further include operations, features, means, or instructions for transmitting a second CSI report that may be not associated with self-interference measurements of the UE.

Some examples of the method, UEs, and non-transitory computer-readable medium described herein may further include operations, features, means, or instructions for receiving second control information that may be not associated with self-interference measurements of the UE, where transmitting the second CSI report may be based on receiving the second control information.

Some examples of the method, UEs, and non-transitory computer-readable medium described herein may further include operations, features, means, or instructions for receiving an indication via a downlink control information (DCI) message, a medium access control-control element (MAC-CE) message, a radio resource control (RRC) message, a field of the control information, or any combination thereof, of whether the UE may be to transmit the CSI report or transmit both the CSI report and the second CSI report, where transmitting the second CSI report may be based on the indication.

Some examples of the method, UEs, and non-transitory computer-readable medium described herein may further include operations, features, means, or instructions for transmitting, via the CSI report, one or more second CSI metrics different from the one or more first CSI metrics, where the one or more second CSI metrics may be associated with interference measurements other than self-interference measurements.

In some examples of the method, UEs, and non-transitory computer-readable medium described herein, one or more uplink resources associated with the full-duplex communications do not overlap with one or more downlink resources associated with the full-duplex communications.

In some examples of the method, UEs, and non-transitory computer-readable medium described herein, one or more uplink resources associated with the full-duplex communications at least partially overlap with one or more downlink resources associated with the full-duplex communications.

In some examples of the method, UEs, and non-transitory computer-readable medium described herein, the first CSI measurement may be associated with a layer one (L1) measurement.

A method for wireless communication by a UE is described. The method may include receiving control information that includes a configuration for a self-interference measurement, where the self-interference measurement is associated with full-duplex communications of the UE, performing the self-interference measurement in accordance with the configuration, and transmitting, based on the performing, a self-interference CSI report including one or more self-interference CSI metrics associated with the self-interference measurement.

A UE for wireless communication is described. The UE may include one or more memories storing processor executable code, and one or more processors coupled with the one or more memories. The one or more processors may individually or collectively operable to execute the code to cause the UE to receive control information that includes a configuration for a self-interference measurement, where the self-interference measurement is associated with full-duplex communications of the UE, perform the self-interference measurement in accordance with the configuration, and transmit, based on the performing, a self-interference CSI report including one or more self-interference CSI metrics associated with the self-interference measurement.

Another UE for wireless communication is described. The UE may include means for receiving control information that includes a configuration for a self-interference measurement, where the self-interference measurement is associated with full-duplex communications of the UE, means for performing the self-interference measurement in accordance with the configuration, and means for transmitting, based on the performing, a self-interference CSI report including one or more self-interference CSI metrics associated with the self-interference measurement.

A non-transitory computer-readable medium storing code for wireless communication is described. The code may include instructions executable by a processor to receive control information that includes a configuration for a self-interference measurement, where the self-interference measurement is associated with full-duplex communications of the UE, perform the self-interference measurement in accordance with the configuration, and transmit, based on the performing, a self-interference CSI report including one or more self-interference CSI metrics associated with the self-interference measurement.

In some examples of the method, UEs, and non-transitory computer-readable medium described herein, the control information does not include resources for channel measurement and does not include resources associated with interference measurements other than self-interference of the UE based on the control information being associated the self-interference measurement.

Some examples of the method, UEs, and non-transitory computer-readable medium described herein may further include operations, features, means, or instructions for receiving an indication of one or more first resources for a self-interference sounding reference signal (SRS) measurement via a first field of the control information, an indication of one or more second resources for an RSSI measurement via a second field of the control information, or both, where the first field and the second field may be associated with the configuration.

In some examples of the method, UEs, and non-transitory computer-readable medium described herein, the one or more self-interference CSI metrics may be associated with a reference signal received power (RSRP) measurement for self-interference, an RSSI measurement for self-interference, a signal-to-interference and noise ratio (SINR) measurement for self-interference, or any combination thereof.

Some examples of the method, UEs, and non-transitory computer-readable medium described herein may further include operations, features, means, or instructions for receiving, via the control information, an indication of one or more resources for a channel measurement that may be associated with the self-interference measurement, where each resource of the one or more resources for the channel measurement may be associated with at least one self-interference CSI metric.

In some examples of the method, UEs, and non-transitory computer-readable medium described herein, one or more uplink resources associated with the full-duplex communications do not overlap with one or more downlink resources associated with the full-duplex communications.

In some examples of the method, UEs, and non-transitory computer-readable medium described herein, one or more uplink resources associated with the full-duplex communications at least partially overlap with one or more downlink resources associated with the full-duplex communications.

In some examples of the method, UEs, and non-transitory computer-readable medium described herein, the self-interference measurement may be associated with an L1 measurement.

A method for wireless communication by a UE is described. The method may include receiving control information that identifies a configuration for a CSI measurement, where the CSI measurement is associated with measuring self-interference of the UE in one or more subbands associated with SBFD communications by the UE, performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof, and transmitting a report of the CSI measurement based on the performing.

A UE for wireless communication is described. The UE may include one or more memories storing processor executable code, and one or more processors coupled with the one or more memories. The one or more processors may individually or collectively operable to execute the code to cause the UE to receive control information that identifies a configuration for a CSI measurement, where the CSI measurement is associated with measuring self-interference of the UE in one or more subbands associated with SBFD communications by the UE, perform the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof, and transmit a report of the CSI measurement based on the performing.

Another UE for wireless communication is described. The UE may include means for receiving control information that identifies a configuration for a CSI measurement, where the CSI measurement is associated with measuring self-interference of the UE in one or more subbands associated with SBFD communications by the UE, means for performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof, and means for transmitting a report of the CSI measurement based on the performing.

A non-transitory computer-readable medium storing code for wireless communication is described. The code may include instructions executable by a processor to receive control information that identifies a configuration for a CSI measurement, where the CSI measurement is associated with measuring self-interference of the UE in one or more subbands associated with SBFD communications by the UE, perform the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof, and transmit a report of the CSI measurement based on the performing.

Some examples of the method, UEs, and non-transitory computer-readable medium described herein may further include operations, features, means, or instructions for receiving a time and frequency resource configuration for one or more downlink subbands of the one or more subbands and one or more uplink subbands of the one or more subbands, where performing the CSI measurement and transmitting the report may be based on the time and frequency resource configuration.

Some examples of the method, UEs, and non-transitory computer-readable medium described herein may further include operations, features, means, or instructions for receiving a time and frequency resource configuration for one or more downlink subbands of the one or more subbands and one or more uplink subbands of the one or more subbands, where the CSI measurement may be performed in accordance with the second measurement or in accordance with the third measurement based on the time and frequency resource configuration.

Some examples of the method, UEs, and non-transitory computer-readable medium described herein may further include operations, features, means, or instructions for receiving a time and frequency resource configuration for one or more downlink subbands of the one or more subbands and one or more uplink subbands of the one or more subbands, where the CSI measurement may be performed in accordance with the first measurement based on the time and frequency resource configuration.

Some examples of the method, UEs, and non-transitory computer-readable medium described herein may further include operations, features, means, or instructions for receiving a time and frequency resource configuration for one or more downlink subbands of the one or more subbands and one or more uplink subbands of the one or more subbands, where the CSI measurement may be performed in accordance with the first measurement and in accordance with the second measurement or the third measurement based on the time and frequency resource configuration.

Some examples of the method, UEs, and non-transitory computer-readable medium described herein may further include operations, features, means, or instructions for receiving, via the control information, an indication of a size for each subband to be measured of the one or more subbands, where performing the CSI measurement may be based on the indication.

In some examples of the method, UEs, and non-transitory computer-readable medium described herein, the indication includes a bitmap that identifies the one or more subbands that may be measured for self-interference via the CSI measurement.

Some examples of the method, UEs, and non-transitory computer-readable medium described herein may further include operations, features, means, or instructions for receiving an indication that identifies that the CSI measurement may be performed in accordance with the first measurement, with the second measurement, or with the third measurement.

In some examples of the method, UEs, and non-transitory computer-readable medium described herein, the indication may be received via a MAC-CE message, a DCI message, an RRC message, or any combination thereof.

Some examples of the method, UEs, and non-transitory computer-readable medium described herein may further include operations, features, means, or instructions for transmitting a second report of second CSI measurement, where the report may be associated with the first measurement and the second report may be associated with the second measurement or the third measurement.

In some examples of the method, UEs, and non-transitory computer-readable medium described herein, a self-interference metric associated with the CSI measurement may be based on a type of CSI measurement.

Some examples of the method, UEs, and non-transitory computer-readable medium described herein may further include operations, features, means, or instructions for receiving, via the control information, an indication of respective self-interference metrics that may be associated with each of the one or more subbands, where transmitting the report may be based on the indication.

Some examples of the method, UEs, and non-transitory computer-readable medium described herein may further include operations, features, means, or instructions for receiving, via the control information, an indication of a first subband reporting configuration associated with a precoding matrix indicator (PMI) measurement, a channel quality indication (CQI) measurement, or both, where a second subband reporting configuration for transmitting the report may be a same subband reporting configuration as the first subband reporting configuration.

Some examples of the method, UEs, and non-transitory computer-readable medium described herein may further include operations, features, means, or instructions for receiving, via the control information, an indication of a first subband reporting configuration associated with a PMI measurement, a CQI measurement, or both and modifying the first subband reporting configuration to obtain a second subband reporting configuration for transmitting the report.

Some examples of the method, UEs, and non-transitory computer-readable medium described herein may further include operations, features, means, or instructions for receiving, via a field of the control information, an indication of a subband measurement reporting configuration for transmitting the report, where the subband measurement reporting configuration identifies one or more measurement subbands for performing the CSI measurement.

In some examples of the method, UEs, and non-transitory computer-readable medium described herein, the CSI measurement may be associated with an L1 measurement, a layer three (L3) measurement, or both.

A method for wireless communication by a network entity is described. The method may include transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE and receiving, based on transmitting the control information, a CSI report including one or more first CSI metrics, where each CSI metric of the one or more first CSI metrics is associated with both of the first CSI measurement and the second CSI measurement.

A network entity for wireless communication is described. The network entity may include one or more memories storing processor executable code, and one or more processors coupled with the one or more memories. The one or more processors may individually or collectively operable to execute the code to cause the network entity to transmit control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE and receive, based on transmitting the control information, a CSI report including one or more first CSI metrics, where each CSI metric of the one or more first CSI metrics is associated with both of the first CSI measurement and the second CSI measurement.

Another network entity for wireless communication is described. The network entity may include means for transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE and means for receiving, based on transmitting the control information, a CSI report including one or more first CSI metrics, where each CSI metric of the one or more first CSI metrics is associated with both of the first CSI measurement and the second CSI measurement.

A non-transitory computer-readable medium storing code for wireless communication is described. The code may include instructions executable by a processor to transmit control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE and receive, based on transmitting the control information, a CSI report including one or more first CSI metrics, where each CSI metric of the one or more first CSI metrics is associated with both of the first CSI measurement and the second CSI measurement.

Some examples of the method, network entities, and non-transitory computer-readable medium described herein may further include operations, features, means, or instructions for transmitting an indication of one or more resources for the first CSI measurement via a field of the control information that may be associated with self-interference.

Some examples of the method, network entities, and non-transitory computer-readable medium described herein may further include operations, features, means, or instructions for transmitting an indication of one or more first resources for a SRS measurement via a first field of the control information, an indication of one or more second resources for an RSSI measurement via a second field of the control information, or both, where the first field and the second field may be associated with the first configuration.

In some examples of the method, network entities, and non-transitory computer-readable medium described herein, the one or more first CSI metrics may be associated with self-interference, a channel measurement, and one or more of inter-cell interference, MU-MIMO interference, and CLI.

In some examples of the method, network entities, and non-transitory computer-readable medium described herein, the one or more first CSI metrics may be associated with an identifier that indicates that the one or more first CSI metrics may be associated with self-interference.

Some examples of the method, network entities, and non-transitory computer-readable medium described herein may further include operations, features, means, or instructions for receiving a second CSI report that may be not associated with self-interference measurements of the UE.

Some examples of the method, network entities, and non-transitory computer-readable medium described herein may further include operations, features, means, or instructions for transmitting second control information that may be not associated with self-interference measurements of the UE, where transmitting the second CSI report may be based on receiving the second control information.

Some examples of the method, network entities, and non-transitory computer-readable medium described herein may further include operations, features, means, or instructions for transmitting an indication via a DCI message, a MAC-CE message, an RRC message, a field of the control information, or any combination thereof, of whether the UE may be to transmit the CSI report or transmit both the CSI report and the second CSI report, where receiving the second CSI report may be based on the indication.

Some examples of the method, network entities, and non-transitory computer-readable medium described herein may further include operations, features, means, or instructions for receiving, via the CSI report, one or more second CSI metrics different from the one or more first CSI metrics, where the one or more second CSI metrics may be associated with interference measurements other than self-interference measurements.

In some examples of the method, network entities, and non-transitory computer-readable medium described herein, one or more uplink resources associated with the full-duplex communications do not overlap with one or more downlink resources associated with the full-duplex communications.

In some examples of the method, network entities, and non-transitory computer-readable medium described herein, one or more uplink resources associated with the full-duplex communications at least partially overlap with one or more downlink resources associated with the full-duplex communications.

In some examples of the method, network entities, and non-transitory computer-readable medium described herein, the first CSI measurement may be associated with an L1 measurement.

A method for wireless communication by a network entity is described. The method may include transmitting control information that includes a configuration for a self-interference measurement, where the self-interference measurement is associated with full-duplex communications of a UE and receiving, based on transmitting the control information, a self-interference CSI report including one or more self-interference CSI metrics associated with the self-interference measurement.

A network entity for wireless communication is described. The network entity may include one or more memories storing processor executable code, and one or more processors coupled with the one or more memories. The one or more processors may individually or collectively operable to execute the code to cause the network entity to transmit control information that includes a configuration for a self-interference measurement, where the self-interference measurement is associated with full-duplex communications of a UE and receive, based on transmitting the control information, a self-interference CSI report including one or more self-interference CSI metrics associated with the self-interference measurement.

Another network entity for wireless communication is described. The network entity may include means for transmitting control information that includes a configuration for a self-interference measurement, where the self-interference measurement is associated with full-duplex communications of a UE and means for receiving, based on transmitting the control information, a self-interference CSI report including one or more self-interference CSI metrics associated with the self-interference measurement.

A non-transitory computer-readable medium storing code for wireless communication is described. The code may include instructions executable by a processor to transmit control information that includes a configuration for a self-interference measurement, where the self-interference measurement is associated with full-duplex communications of a UE and receive, based on transmitting the control information, a self-interference CSI report including one or more self-interference CSI metrics associated with the self-interference measurement.

In some examples of the method, network entities, and non-transitory computer-readable medium described herein, the control information does not include resources for channel measurement and does not include resources associated with interference measurements other than self-interference of the UE based on the control information being associated the self-interference measurement.

Some examples of the method, network entities, and non-transitory computer-readable medium described herein may further include operations, features, means, or instructions for transmitting an indication of one or more first resources for a self-interference SRS measurement via a first field of the control information, an indication of one or more second resources for an RSSI measurement via a second field of the control information, or both, where the first field and the second field may be associated with the configuration.

In some examples of the method, network entities, and non-transitory computer-readable medium described herein, the one or more self-interference CSI metrics may be associated with an RSRP measurement for self-interference, an RSSI measurement for self-interference, an SINR measurement for self-interference, or any combination thereof.

Some examples of the method, network entities, and non-transitory computer-readable medium described herein may further include operations, features, means, or instructions for transmitting, via the control information, an indication of one or more resources for a channel measurement that may be associated with the self-interference measurement, where each resource of the one or more resources for the channel measurement may be associated with at least one self-interference CSI metric.

In some examples of the method, network entities, and non-transitory computer-readable medium described herein, one or more uplink resources associated with the full-duplex communications do not overlap with one or more downlink resources associated with the full-duplex communications.

In some examples of the method, network entities, and non-transitory computer-readable medium described herein, one or more uplink resources associated with the full-duplex communications at least partially overlap with one or more downlink resources associated with the full-duplex communications.

In some examples of the method, network entities, and non-transitory computer-readable medium described herein, the self-interference measurement may be associated with an L1 measurement.

A method for wireless communication by a network entity is described. The method may include transmitting control information that identifies a configuration for a CSI measurement, where the CSI measurement is associated with measuring self-interference of a UE in one or more subbands associated with SBFD communications by the UE and receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

A network entity for wireless communication is described. The network entity may include one or more memories storing processor executable code, and one or more processors coupled with the one or more memories. The one or more processors may individually or collectively operable to execute the code to cause the network entity to transmit control information that identifies a configuration for a CSI measurement, where the CSI measurement is associated with measuring self-interference of a UE in one or more subbands associated with SBFD communications by the UE and receive a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

Another network entity for wireless communication is described. The network entity may include means for transmitting control information that identifies a configuration for a CSI measurement, where the CSI measurement is associated with measuring self-interference of a UE in one or more subbands associated with SBFD communications by the UE and means for receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

A non-transitory computer-readable medium storing code for wireless communication is described. The code may include instructions executable by a processor to transmit control information that identifies a configuration for a CSI measurement, where the CSI measurement is associated with measuring self-interference of a UE in one or more subbands associated with SBFD communications by the UE and receive a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

Some examples of the method, network entities, and non-transitory computer-readable medium described herein may further include operations, features, means, or instructions for transmitting a time and frequency resource configuration for one or more downlink subbands of the one or more subbands and one or more uplink subbands of the one or more subbands, where receiving the report may be based on the time and frequency resource configuration.

Some examples of the method, network entities, and non-transitory computer-readable medium described herein may further include operations, features, means, or instructions for transmitting a time and frequency resource configuration for one or more downlink subbands of the one or more subbands and one or more uplink subbands of the one or more subbands, where the CSI measurement may be performed by the UE in accordance with the second measurement or in accordance with the third measurement based on the time and frequency resource configuration.

Some examples of the method, network entities, and non-transitory computer-readable medium described herein may further include operations, features, means, or instructions for transmitting a time and frequency resource configuration for one or more downlink subbands of the one or more subbands and one or more uplink subbands of the one or more subbands, where the CSI measurement may be performed by the UE in accordance with the first measurement based on the time and frequency resource configuration.

Some examples of the method, network entities, and non-transitory computer-readable medium described herein may further include operations, features, means, or instructions for transmitting a time and frequency resource configuration for one or more downlink subbands of the one or more subbands and one or more uplink subbands of the one or more subbands, where the CSI measurement may be performed by the UE in accordance with the first measurement and in accordance with the second measurement or the third measurement based on the time and frequency resource configuration.

Some examples of the method, network entities, and non-transitory computer-readable medium described herein may further include operations, features, means, or instructions for transmitting, via the control information, an indication of a size for each subband to be measured of the one or more subbands, where receiving the report may be based on transmitting the indication.

In some examples of the method, network entities, and non-transitory computer-readable medium described herein, the indication includes a bitmap that identifies the one or more subbands that may be measured for self-interference via the CSI measurement.

Some examples of the method, network entities, and non-transitory computer-readable medium described herein may further include operations, features, means, or instructions for transmitting an indication that identifies that the CSI measurement may be performed in accordance with the first measurement, with the second measurement, or with the third measurement.

In some examples of the method, network entities, and non-transitory computer-readable medium described herein, the indication may be received via a MAC-CE message, a DCI message, an RRC message, or any combination thereof.

Some examples of the method, network entities, and non-transitory computer-readable medium described herein may further include operations, features, means, or instructions for receiving a second report of second CSI measurement, where the report may be associated with the first measurement and the second report may be associated with the second measurement or the third measurement.

In some examples of the method, network entities, and non-transitory computer-readable medium described herein, a self-interference metric associated with the CSI measurement may be based on a type of CSI measurement.

Some examples of the method, network entities, and non-transitory computer-readable medium described herein may further include operations, features, means, or instructions for transmitting, via the control information, an indication of respective self-interference metrics that may be associated with each of the one or more subbands, where receiving the report may be based on the indication.

Some examples of the method, network entities, and non-transitory computer-readable medium described herein may further include operations, features, means, or instructions for transmitting, via the control information, a first subband reporting configuration associated with a PMI measurement, a CQI measurement, or both, where a second subband reporting configuration for transmitting the report may be a same subband reporting configuration as the first subband reporting configuration.

Some examples of the method, network entities, and non-transitory computer-readable medium described herein may further include operations, features, means, or instructions for transmitting, an indication of a first subband reporting configuration associated with a PMI measurement, a CQI measurement, or both, where the report may be received in accordance with a second subband reporting configuration based on transmitting the indication, and where the second subband reporting configuration may be a modified version of the first subband reporting configuration.

Some examples of the method, network entities, and non-transitory computer-readable medium described herein may further include operations, features, means, or instructions for transmitting, via a field of the control information, an indication of a subband measurement reporting configuration for transmitting the report, where the subband measurement reporting configuration identifies one or more measurement subbands for performing the CSI measurement.

In some examples of the method, network entities, and non-transitory computer-readable medium described herein, the CSI measurement may be associated with an L1 measurement, an L3 measurement, or both.

### BRIEF DESCRIPTION OF THE DRAWINGS

FIG. 1 shows an example of a wireless communications system that supports techniques for channel state information (CSI) reporting in full-duplex communication modes in accordance with one or more aspects of the present disclosure.

FIG. 2 shows an example of a wireless communications system that supports techniques for CSI reporting in full-duplex communication modes in accordance with one or more aspects of the present disclosure.

FIG. 3 shows an example of a block diagram of a configuration that supports techniques for CSI reporting in full-duplex communication modes in accordance with one or more aspects of the present disclosure.

FIG. 4 shows an example of a block diagram of a configuration that supports techniques for CSI reporting in full-duplex communication modes in accordance with one or more aspects of the present disclosure.

FIG. 5 shows examples of CSI measurement configurations that support techniques for CSI reporting in full-duplex communication modes in accordance with one or more aspects of the present disclosure.

FIG. 6 shows an example of a process flow that supports techniques for CSI reporting in full-duplex communication modes in accordance with one or more aspects of the present disclosure.

FIGS. 7 and 8 show block diagrams of devices that support techniques for CSI reporting in full-duplex communication modes in accordance with one or more aspects of the present disclosure.

FIG. 9 shows a block diagram of a communications manager that supports techniques for CSI reporting in full-duplex communication modes in accordance with one or more aspects of the present disclosure.

FIG. 10 shows a diagram of a system including a device that supports techniques for CSI reporting in full-duplex communication modes in accordance with one or more aspects of the present disclosure.

FIGS. 11 and 12 show block diagrams of devices that support techniques for CSI reporting in full-duplex communication modes in accordance with one or more aspects of the present disclosure.

FIG. 13 shows a block diagram of a communications manager that supports techniques for CSI reporting in full-duplex communication modes in accordance with one or more aspects of the present disclosure.

FIG. 14 shows a diagram of a system including a device that supports techniques for CSI reporting in full-duplex communication modes in accordance with one or more aspects of the present disclosure.

FIGS. 15 through 21 show flowcharts illustrating methods that support techniques for CSI reporting in full-duplex communication modes in accordance with one or more aspects of the present disclosure.

### DETAILED DESCRIPTION

Some wireless communication systems may support full-duplex communications, where a wireless device may simultaneously transmit and receive wireless signals (e.g., a user equipment (UE) and a network entity may communicate uplink signals and downlink signals during a same slot). Such wireless communication systems may support various implementations of full-duplex communications. For example, subband full-duplex (SBFD) may allocate different frequency resources (e.g., non-overlapping frequency resources, different subbands) for uplink communications and downlink communications. In other examples, frequency resources for uplink and downlink communications may at least partially overlap. Full-duplex communications may support benefits for a wireless communication system such as decreased latency, improved efficiency of resource utilization, and enhanced system capacity. However, in full-duplex communications, transmitting antennas and receiving antennas may be active at a same time and may be relatively close together (e.g., for a UE). As such, wireless signals from a transmitting antenna of a wireless device may interfere with (e.g., leak into) a receiving antenna of the wireless device (e.g., and vice-versa), which, in some cases, may be referred to as self-interference. Moreover, some techniques for measuring and reporting communication channel quality (e.g., existing CSI measurement and CSI report techniques) may not account for self-interference. Accordingly, it may be beneficial for a wireless device (e.g., a UE) to support techniques to measure self-interference and to report self-interference to improve communication quality of full-duplex communications.

In accordance with aspects described herein, a UE and a network entity may exchange signaling and support techniques to perform self-interference measurements and to report one or more metrics (e.g., or other information) associated with the self-interference measurements. For example, a network entity may transmit control information (e.g., via control signaling, via configuration signaling, via a CSI-ReportConfig information element (IE)) that includes one or more CSI configurations to a UE. At least one of the one or more CSI configurations may be associated with a self-interference measurement configuration, a self-interference reporting configuration, or both. In some examples, the network entity may configure the UE to perform and report self-interference measurements in conjunction with other CSI measurements. For instance, a UE may capture self-interference measurements in other CSI report mechanisms (e.g., self-interference measurements may be implicitly absorbed in existing CSI report metrics). In some other examples, the network entity may configure the UE to perform and report self-interference separately from other CSI measurements (e.g., dedicated self-interference report metrics, self-interference measurements may be explicitly reported).

In some examples, a UE may perform and report self-interference measurements that are associated with one or more subbands (e.g., uplink subbands, downlink subbands) based on a resource configuration (e.g., an SBFD resource configuration). In some examples, the UE may be configured (e.g., based on control information or a rule) to measure and report various self-interference metrics for a given subband. For instance, in accordance with a first method, a UE may measure a first metric (e.g., received signal strength indicator (RSSI), signal-to-interference and noise ratio (SINR), or other metric) within one or more downlink subbands. In accordance with a second method, a UE may measure a second metric (e.g., reference signal received power (RSRP), or other metric) within one or more uplink subbands. In accordance with a third method, the UE may measure the first metric (e.g., RSSI, or some other metric) within one or more uplink subbands. In some examples, the UE may (e.g., implicitly) determine one or more self-interference metrics to measure and one or more subbands (e.g., range of frequency resources) in which to perform the measurement (e.g., based on an SBFD resource configuration, based on a supported method). Additionally, or alternatively, the UE may be configured (e.g., by a network entity, via control signaling) with the one or more self-interference metrics to measure and the one or more subbands.

A wireless communication system may utilize one or more techniques described herein to improve communication quality associated with full-duplex communications by enabling CSI measurements to more accurately account for self-interference. For instance, the various signaling mechanisms and other mechanisms described herein may provide benefits such as improved beam management procedures, higher data rates, increased system capacity, and enhanced spectral efficiency, among other benefits. Aspects of the disclosure are initially described in the context of wireless communications systems. Aspects of the disclosure are further illustrated by and described with reference to block diagrams, CSI measurement configurations, process flows, apparatus diagrams, system diagrams, and flowcharts that relate to techniques for CSI reporting in full-duplex communication modes.

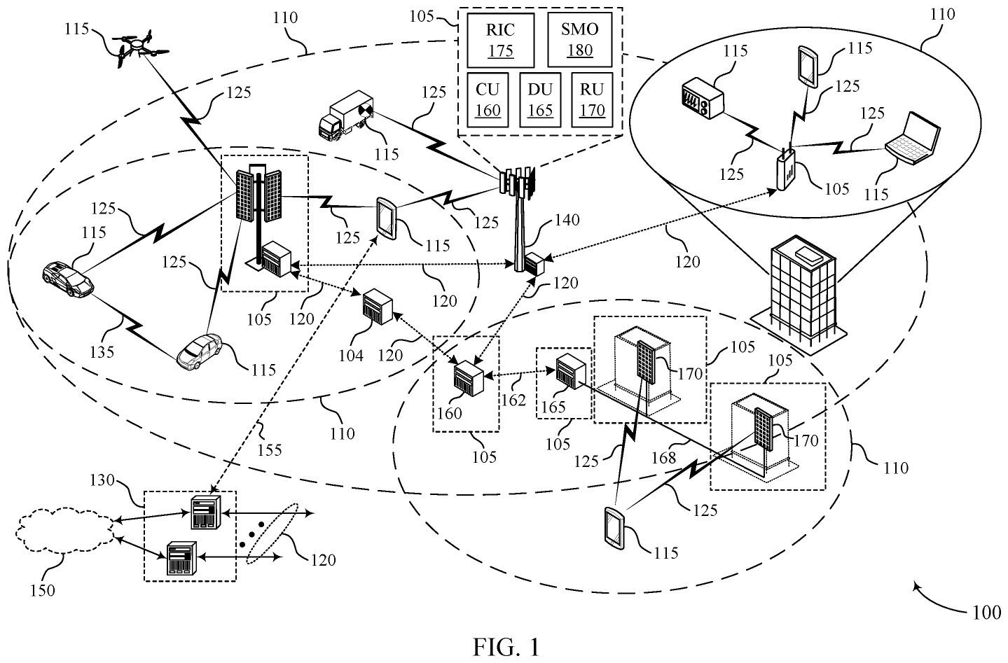

FIG. 1 shows an example of a wireless communications system 100 that supports techniques for CSI reporting in full-duplex communication modes in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for CSI reporting in full-duplex communication modes as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support full-duplex communications, where a wireless device (e.g., a UE 115, a network entity 105, or some other device) may transmit and receive wireless signals a same time resource (e.g., uplink communications and downlink communications may be active at a same time). Full-duplex communications may decrease latency and improve efficiency of the wireless communications system 100. However, transmitting antennas and receiving antennas may be active at a same time in full-duplex communications and may be relatively close together. As such, wireless signals from a transmitting (e.g., uplink) antenna and a receiving (e.g., downlink) antenna (e.g., of a UE 115) may interfere with each other, and some techniques for measuring and reporting communication channel quality (e.g., existing CSI measurement and CSI report techniques) may not account for such interference (e.g., self-interference).

In accordance with aspects described herein, a UE 115 and a network entity 105 may support signaling and other mechanisms to enable the wireless communications system 100 to more accurately account for self-interference associated with full-duplex communications. In some examples, a network entity 105 may transmit control signaling that includes one or more CSI configurations (e.g., self-interference CSI configurations, non-self-interference CSI configurations, channel measurement configurations) to a UE 115. In some examples, a UE 115 may absorb (e.g., implicitly account for) self-interference CSI measurements into other CSI reporting quantities. In some other examples, the network entity 105 may explicitly configure the UE 115 to perform and report one or more dedicated self-interference measurements. In some examples, a UE 115 may perform and report self-interference measurements that are based on a subband resource configuration (e.g., an SBFD resource configuration). For instance, the UE 115 may be configured (e.g., indicated, preconfigured) to measure and report various self-interference metrics in a specific subband (e.g., or a portion of a subband) in accordance with one or more methods. Thus, by utilizing one or more techniques herein, the wireless communications system 100 may support increased communication quality, improved beam management procedures, higher data rates, increased system capacity, and enhanced spectral efficiency, among other benefits.

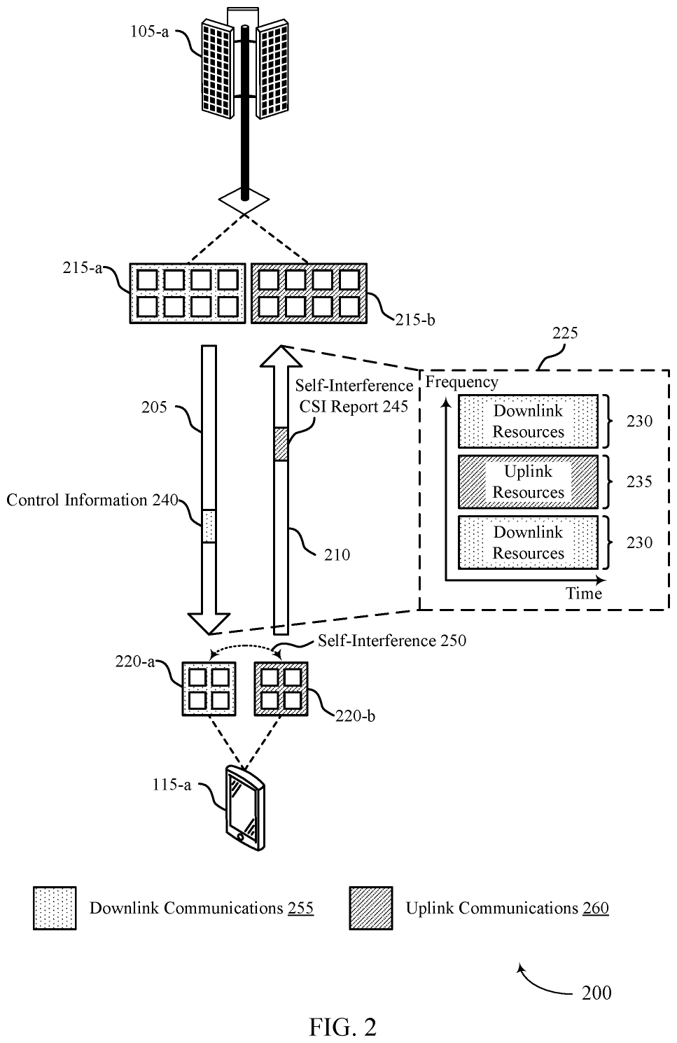

FIG. 2 shows an example of a wireless communications system 200 that supports techniques for CSI reporting in full-duplex communication modes in accordance with one or more aspects of the present disclosure. The wireless communications system 200 may implement or be implemented by aspects of the wireless communications system 100. For example, the wireless communications system 200 may include a network entity 105-a and a UE 115-a, which may be examples of, or include, a network entity 105 and UE 115 described with reference to FIG. 1. Although a network entity 105-a and a UE 115-a are shown, the techniques herein may be applied by one or more other devices described herein, including with reference to FIG. 1. The network entity 105-a may communicate with the UE 115-a using a downlink communication link 205 and an uplink communication link 210. In some examples, the network entity 105-a, the UE 115-a, or both, may apply one or more techniques as described herein to account for self-interference 250 as part of (e.g., or in addition to) CSI procedures, which may to improve full-duplex communications in the wireless communications system 200.

In some examples, one or more communication devices operating within the wireless communications system 200 (e.g., the network entity 105-a, the UE 115-a) may support communications using one or more full-duplex communication schemes (e.g., SBFD or overlapping full-duplex). For instance, a network entity 105-a may use subband-based full-duplex to simultaneously (e.g., in a same slot) serve one or more downlink UEs and one or more uplink UEs on corresponding subbands (e.g., simultaneous transmission/reception of downlink/uplink on a subband basis). In some cases, each subband (e.g., downlink subbands 230 and uplink subbands 235) may be separated by a guard band (e.g., certain quantity of RBs may be introduced between each subbands. In some other examples, each subband may not be separated by a guard band (e.g., downlink subbands 230 and uplink subbands 235 may at least partially overlap or may fully overlap).

The resource diagram 225 may show an example of a subband pattern for the communication between the network entity 105-a and the UE 115-a. As a non-limiting example, the resource diagram 225 may include one or more downlink subbands 230 and one or more uplink subbands 235. The subband pattern may include resources for at least one component carrier (e.g., a component carrier bandwidth, SBFD in a TDD carrier, SBFD in an intra-band carrier aggregation (CA) based scheme). Although resource diagram 225 shows an example subband resource pattern (e.g., a downlink-uplink-downlink SBFD pattern), it is to be understood that the resource diagram 225 may include various patterns of downlink subbands 230 and uplink subbands 235 (e.g., a downlink-uplink SBFD pattern).

In some cases, full-duplex communications (e.g., SBFD communications) may provide an increased uplink duty cycle which may reduce latency. For example, SBFD communication may enable communication of an uplink signal in one or more uplink subbands 235 (e.g., in downlink only slots, in flexible slots) or communication of a downlink signal in one or more downlink subbands 230 in (e.g., in uplink only slots), which may enable latency savings. In some cases, full-duplex communications may improve coverage, enhance system capacity, enhance resource utilization, enhance spectrum efficiency, and enable flexible and dynamic uplink/downlink resource adaption (e.g., according to uplink/downlink traffic in a relatively robust manner).

In some cases, a network entity 105-a may support full-duplex communications while one or more UEs 115 (not shown) may support half-duplex communications (e.g., the network entity 105-a may communicate via a downlink communication link 205 with one UE and via an uplink communication link 210 with a another UE). In such cases, some time resources may be configured for half-duplex communications while other time resources may be configured for full-duplex communications (e.g., some symbols or slots may be configured for half-duplex, and some symbols or slots may be configured for SBFD).

In some cases, to enhance system capacity, uplink coverage, reduce latency, and achieve other benefits, a UE 115-a (e.g., SBFD UEs, partial overlapping or fully overlapping full-duplex UEs) may additionally support full-duplex communications. For example, the UE 115-a may include one or more antennas 220 (e.g., antenna arrays, antenna panels), which may include a downlink antenna 220-a in support of downlink communications 255 and an uplink antenna 220-b in support of uplink communications 260. Additionally, the network entity 105-a may include one or more antennas 215 (e.g., antenna arrays, antenna panels), which may include an downlink antenna 215-a and an uplink antenna 215-b. The network entity 105-a and the UE 115-a may perform downlink communications 255, such as downlink control signals (e.g., physical downlink control channel (PDCCH) signals) or downlink data signals (e.g., physical downlink shared channel (PDSCH) signals), to the UE 115-a via the downlink communication link 205 (e.g., a downlink beam). Additionally (e.g., simultaneously), the UE 115-a and the network entity 105-a may perform uplink communications 260, such as uplink control signals (e.g., physical uplink control channel (PUCCH) signals) or uplink data signals (e.g., physical uplink shared channel (PUSCH) signals) via the uplink communication link 210 (e.g., an uplink beam).

In some cases, enabling the UE 115-a (e.g., SBFD UE, full-duplex UE) for full-duplex communications may result in self-interference 250. The self-interference 250 may be leaked interference (e.g., clutter echo) from uplink signaling (e.g., via a transmitting antenna 220-b) of the UE 115-a into downlink signaling (e.g., into a receiving antenna 220-a) of the UE 115-a. Accordingly, it may be beneficial to measure and report the self-interference 250 as part of CSI procedures (e.g., CSI measurement and CSI reporting), beam management procedures (e.g., beam selection), or other procedures. However, existing procedures (e.g., existing CSI procedures) may not support mechanisms that enable wireless devices to account for the self-interference 250. For instance, some procedures may result in selection of a communication beam that may be satisfactory with respect to existing metrics (e.g., RSRP) but may be associated with relatively high self-interference. As such, it may be beneficial for the devices of the wireless communications system 200 to support signaling and mechanisms that enable measurement and reporting of self-interference 250 to improve communication quality associate with full-duplex communications.

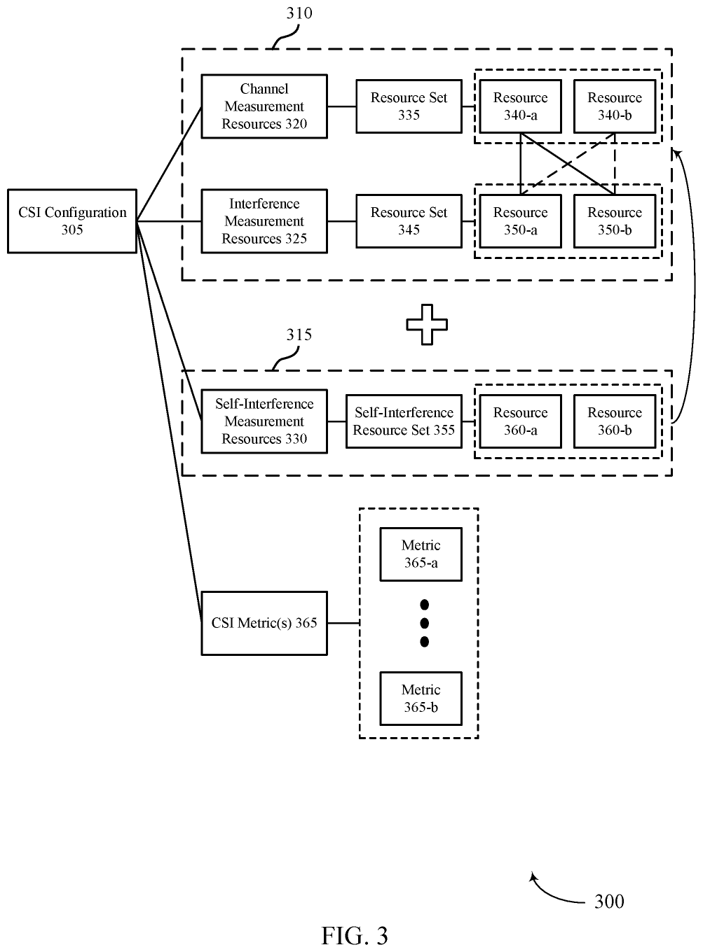

In accordance with techniques described herein, CSI mechanisms (e.g., a CSI framework) may be enhanced, to enable self-interference measurement and reporting for the UE 115-a, the network entity 105-a, or both. In some examples, self-interference measurements may be implicitly absorbed into a CSI framework by associating dedicated self-interference resources (e.g., as an additional interference measurement resource (IMR)) into a self-interference CSI report 245 (e.g., as described in greater detail herein, including with reference to FIG. 3). In such examples, the UE 115-a may be configured (e.g., by the network entity 105-a) with control information 240 to consider (e.g., capture) both self-interference (e.g., IMR for self-interference resource) and other interference (e.g., from IMR or CSI-interference measurement (CSI-IM), not associated with self-interference) into CSI metrics (e.g., existing CSI metrics, channel quality indicator (CQI), SINR, layer one-SINR (L1-SINR)). The UE 115-a may transmit the self-interference CSI report 245, which may include the CSI metrics which account for the self-interference 250 (e.g., based on one or more configurations of the control information 240).

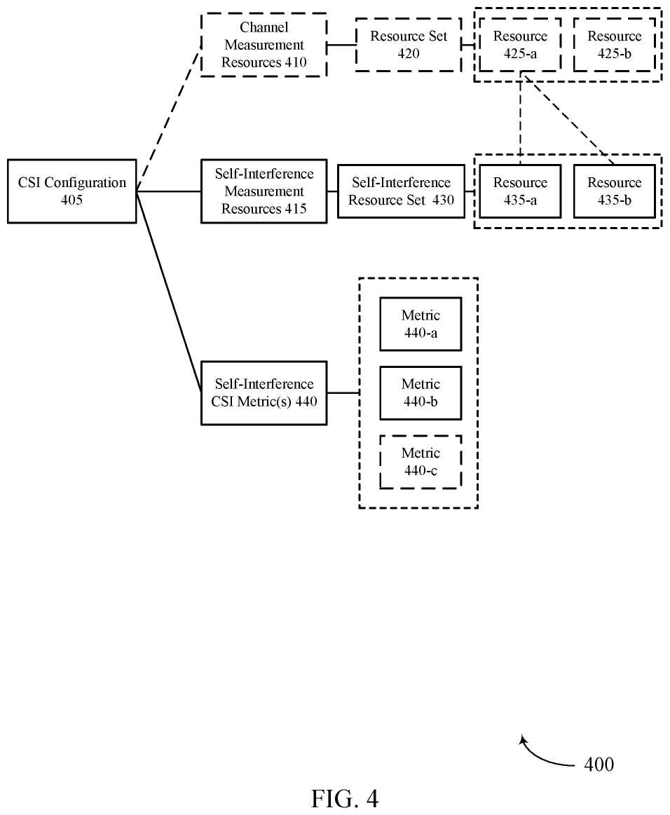

Additionally, or alternatively, self-interference measurements may be explicitly reported as independent self-interference metrics. For example, the UE 115-a may be configured (e.g., by the network entity 105-a) with control information 240 to include dedicated reporting metrics for self-interference (e.g., self-interference-RSRP (SI-RSRP) and self-interference-RSSI (SI-RSSI)) in the self-interference CSI report 245 (e.g., as described in greater detail herein, including with reference to FIG. 4). For example, the self-interference CSI report 245 may be a dedicated to metrics or other information associated with the self-interference 250.

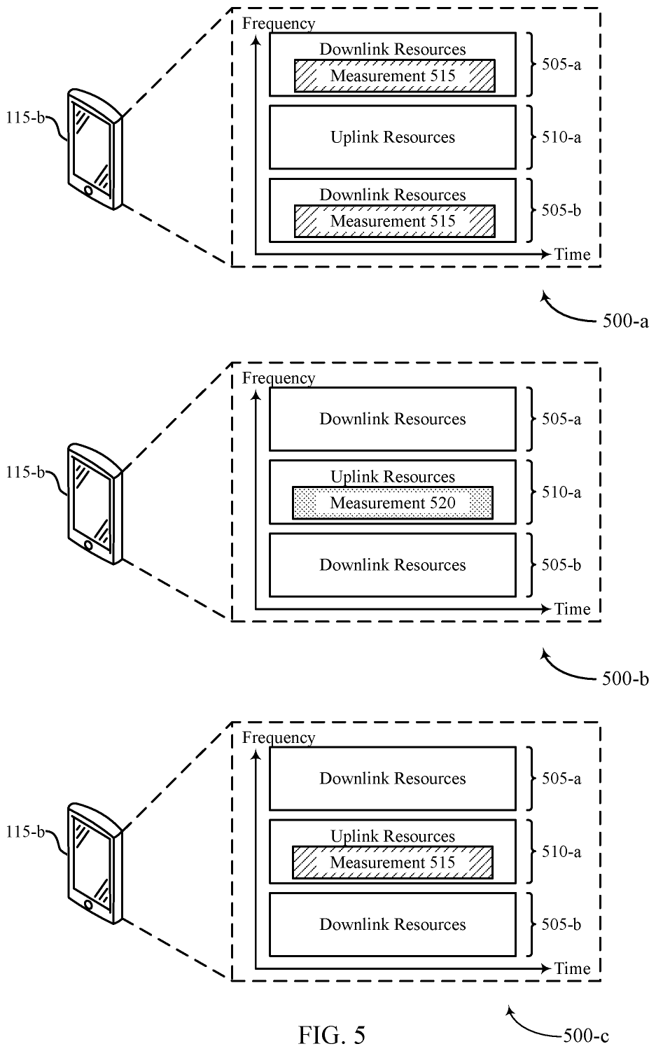

In some examples, self-interference measurement and reporting may be subband-based (e.g., as described in greater detail herein, including with reference to FIG. 5). For instance, the UE 115-a may perform self-interference measurement in one or more downlink subbands 230 (e.g., to measure inter-subband self-interference leakage), in one or more uplink subbands 235 (e.g., to measure self-interference in-band blocking), or both. In some examples, the UE 115-a may be configured (e.g., by the network entity 105-a) with the control information 240, which may include resources (e.g., time and frequency resources) for the subband-based measurements. The UE 115-a may include the subband-based measurement in the self-interference CSI report 245 based on the control information 240.

Accordingly, the wireless communications system 200 may be enabled to account for the self-interference 250 and provide increased communication quality. For instance, the control information 240 and the self-interference CSI report 245 may enable the network entity 105-a and the UE 115-a measure and report the self-interference 250 (e.g., in a CSI framework). Such mechanisms may improve various procedures of the wireless communications system 200 such scheduling (e.g., by the network entity 105-a), mode determination, self-interference mitigation, full-duplex beam pair selection, full-duplex beam management, and other procedures, which may increase data rates, increase system capacity, and enhanced spectral efficiency, among other benefits

FIG. 3 shows an example of a block diagram of a configuration 300 that supports techniques for CSI reporting in full-duplex communication modes in accordance with one or more aspects of the present disclosure. The configuration 300 may include a CSI configuration 305 (e.g., a CSI-ReportConfig IE in RRC signaling, a combined CSI configuration, a CSI configuration including a configuration for self-interference and other interference measurements). The CSI configuration 305 may include CSI configuration information 310, which may include resources for measurements that are not associated with self-interference. The CSI configuration 305 may include CSI configuration information 315, which may include resources for self-interference measurements. The CSI configuration 305 may include one or more CSI metrics 365 (e.g., a reportQuantity field of a CSI-ReportConfig), which may capture or include various metrics associated with one or more measurements that are performed based on the CSI configuration information 310 and the CSI configuration information 315. In some examples, the CSI configuration 305 may be included in the control information 240, and the one or more CSI metrics 365 may be reported in the self-interference CSI report 245 as described with reference to FIG. 2. For example, a UE 115-a may receive the CSI configuration 305 (e.g., via control signaling in the downlink communication link 205) from a network entity 105-a, and the UE 115-a may transmit the one or more CSI metrics 365 (e.g., via a CSI report in the uplink communication link 210) to the network entity 105-a.

In some examples, the CSI configuration information 310 (e.g., existing CSI configurations) may not consider an impact of UE self-interference in reported metrics (e.g., configured metrics for reporting in a self-interference CSI report 245). For example, some interference measurements may be associated with intra-cell cross beam interference, inter-cell downlink interference, or other interference aside from self-interference. However, some mechanisms may be reused (e.g., as an extension of existing CSI framework) to capture the impact of UE (e.g., full-duplex UE) self-interference (e.g., in the existing CSI reportQuantity of metrics including L1-SINR, CSI feedback, CQI, PMI, rank indicator (RI)). That is, some CSI metrics 365 (e.g., existing CSI report metrics) may be updated to (e.g., implicitly) capture self-interference (e.g., the reportQuantity may absorb self-interference measurements based on existing CSI framework). For instance, additional information from self-interference measurements may be combined other measurements and conjunctively captured in the one or more CSI metrics 365 (e.g., with combined calculation for channel measurement resource (CMR), IMR and IMR-self-interference (IMR-SI)). In some examples, self-interference may be reflected on CQI, PMI, RI, and SINR calculations (e.g., for beam management).

In some examples, self-interference may be captured (e.g., implicitly absorbed) into a CSI framework (e.g., existing CSI ReportQuantity) by associating dedicated self-interference resources (e.g., as additional IMR into the CSI report). That is, the CSI configuration 305 may include the CSI configuration information 315 (e.g., self-interference IMR) in addition to the CSI configuration information 310 (e.g., non-self-interference IMR). Accordingly, the CSI configuration 305 may configure a UE 115-a to consider the interference from non-self-interference measurements (e.g., IMR, CSI-IM) and self-interference (e.g., IMR for self-interference) by capturing (e.g., combining) both into existing CSI metrics (e.g., CQI, L1-SINR). As an example, L1-SINR measurement may be used for UE full-duplex beam selection and beam management procedures based on the combined CSI metrics. In some cases, a UE 115-a may receive the CSI configuration 305 from a network entity 105-a to perform self-interference measurement as the UE 115-a may not support autonomous transmission of an uplink signal.

In some examples, the CSI configuration information 310 may include channel measurement resources 320 (e.g., non-zero-power (NZP) CSI-reference signal (CSI-RS) resource setting for channel measurement). Each channel measurement resource 320 may be associated with a resource set 335 (e.g., NZP CMR resource set n). Although, a single resource set 335 is shown, each channel measurement resources 320 may be associated with multiple resource sets 335. Each resource set 335 may include one or more resources 340 (e.g., resources for performing a corresponding channel measurement) including, for example, a resource 340-a (e.g., NZP CMR resource n1, transmission configuration indicator (TCI) state a) and a resource 340-b (e.g., NZP CMR resource n2, transmission configuration indicator (TCI) state b).

The CSI configuration information 310 may include interference measurement resources 325 for one or more types of interference measurements (e.g., CSI-RS resource for interference measurement, CSI-IM, NZP CSI-RS resource setting for interference measurement). Although, a single block of interference measurement resources 325 is shown, the CSI configuration 305 may include multiple instances of interference measurement resources 325 (e.g., a first interference measurement resources 325 may be for CSI-RS resources and a second interference measurement resources 325 may be for NZP CSI-RS resource settings). Each interference measurement resource 325 may be associated with a resource set 345 (e.g., CSI-IM resource set m, NZP IMR resource set s). Although, a single resource set 345 is shown, each interference measurement resource 325 may be associated with multiple resource sets 345. Each resource set 345 may include one or more resources 350 (e.g., resources for performing a corresponding interference measurement) including, for example, a resource 350-a (e.g., CSI-IM resource m1, NZP IMR resource s1) and a resource 350-b (e.g., CSI-IM resource m2, NZP IMR resource s2). In some examples, the resources 340 may be associated with one or more resources 350 (e.g., individually or collectively, a resource-wise association). For instance, each resource 340 (e.g., CMR resource) may be associated with all resources 350 (e.g., with all NZP IMR resources).

In some examples, the CSI configuration information 315 may include self-interference measurement resources 330 (e.g., self-interference (SI) resource setting for SI measurement). Each self-interference measurement resource 330 may be associated with a self-interference resource set 355 (e.g., SI-resource set Resource k). Although, a single self-interference resource set 355 is shown, each self-interference measurement resource 330 may be associated with multiple self-interference resource sets 355. Each self-interference resource set 355 may include one or more resources 360 (e.g., resources for performing a corresponding self-interference measurement) including, for example, a resource 360-a (e.g., SI sounding reference signal (SRS) resource k1, SI-RSSI resource k1) and a resource 360-b (e.g., SI-SRS resource k2, SI-RSSI resource k2). In some examples, each resource 360 (e.g., SI-IMR) may be associated with one or more resources 340 (e.g., CMR), one or more resources 350 (e.g., other IMR), or both.

In some examples, the one or more CSI metrics 365 may include any quantity of metrics (e.g., metric 365-a through metric 365-b) associated with a measurement that is performed based on the CSI configuration 305 (e.g., based on the resource configurations of the CSI configuration information 310 and the CSI configuration information 315). The one or more CSI metrics 365 (e.g., including cri-RI-PMI-CQI, cri-RI-i1, cri-RI-i1-CQI, cri-RI-CQI, cri-RSRP, ssb-Index-RSRP, cri-RI-LI-PMI-CQI, cri-SINR, or other metrics) may be reported by a UE 115-a to a network entity 105-a.

In some examples, the CSI configuration information 315 (e.g., the self-interference measurement report configuration) may include a field to capture self-interference resources (e.g., SI SRS resources) as a dedicated IMR to measure UE self-interference (e.g., a SRS-SI-ResourcesForInterference with an associated SRS-ResourceId). In some examples, the self-interference measurements may be captured under the one or more CSI metrics 365 (e.g., existing CSI metrics, CQI, PMI, RI, L1-SINR or other metrics). For instance, a calculation for a metric may be updated to account for self-interference measurements. Additionally, or alternatively, the CSI configuration information 315 may include a choice between various self-interference measurement types. For instance, the CSI configuration information 315 may include a field (SI-ResourceForInterference) with a choice between a first field for self-interference reference signal measurements (e.g., SI SRS resources, srs-ResourceSet) and a second field for signal strength measurements (e.g., RSSI resources (for on-going uplink), rssi-ResourceSet), or both. The measurement associated with the first field and the second field may be included (e.g., captured) in the one or more CSI metrics 365 or some other metric (e.g., utilizing a new IE). In some examples, the CSI configuration information 315 for self-interference measurements may be associated with layer one (L1) measurements.

In some examples, the one or more CSI metrics 365 (e.g., the reportQuantity metrics in CSI-ReportConfig) may be associated (e.g., according to a rule defined by an industry standard for UE behavior) with self-interference (e.g., may capture self-interference level), channel measurements, inter-cell interference, MU-MIMO interference, IMR cross link interference (CLI) (e.g., CLI-IMR), or other measurements. Additionally, or alternatively, the one or more CSI metrics 365 may include (e.g., or be updated to include) an identifier (e.g., reportQuantity-r20, cri-RI-PMI-CQI-si, cri-RI-i1-si, cri-RI-i1-CQI-si, cri-RI-CQI-si, cri-RI-LI-PMI-CQI-si, or other identifiers) to indicate that the one or more CSI metrics 365 are associated with self-interference. For instance, the one or more CSI metrics 365 metrics may represent UE self-interference-aware metrics (e.g., CQI metrics) based on a rule defined by an industry standard for UE behavior.

In some examples, a UE 115-a may transmit multiple CSI reports based on multiple CSI reporting configurations (e.g., multiple CSI configurations 305, two reportConfig with two CSI reports). For instance, a UE 115-a may receive (e.g., from the network entity 105-a) first control information that includes the CSI configuration information 315 and second control information that does not include the CSI configuration information 315. Accordingly, the UE 115-a may be configured to transmit a first CSI report based on the first control information that includes metrics that account for self-interference measurements and to transmit a second CSI report based on the second control information that does not account for self-interference measurements. In some examples (e.g., if self-interference measurement is aperiodic (AP) or semi-persistent (SP)), a network entity 105-a may transmit signaling (e.g., via a triggering downlink control information (DCI), via a MAC-control element (MAC-CE), via a field of the CSI configuration 305) that indicates whether a single CSI report or multiple CSI reports are to be transmitted by a UE 115-a. Additionally, or alternatively, a UE 115-a may be configured with a single CSI reporting configurations (e.g., one CSI configuration 305), but may report at least two sets of metrics. For instance, the UE 115-a may report a first set of CSI metrics that is associated with self-interference measurements (e.g., and other measurements) a second set of CSI metrics (e.g., different from the first set) that is not associated with self-interference measurements. In some examples, the UE 115-a may use UE full-duplex self-interference-aware CQI metrics for the one or more CSI metrics 365 (e.g., CQI-si) or may include multiple (e.g., two) metrics in the one or more CSI metrics 365 (e.g., CQI and CQI-si). The UE 115-a may report the first and second set of metrics in a same CSI report or different CSI reports based on an indication from the network entity 105-a (e.g., a separate RRC parameter or a field in the CSI configuration 305 may indicate one or two reports). In some examples, CLI-IMR may be additionally considered in the one or more CSI metrics 365 (e.g., in existing reportQuantity).

FIG. 4 shows an example of a block diagram of a configuration 400 that supports techniques for CSI reporting in full-duplex communication modes in accordance with one or more aspects of the present disclosure. The configuration 400 may include a CSI configuration 405 (e.g., a CSI-ReportConfig IE in RRC signaling, a dedicated self-interference CSI configuration). The CSI configuration 405 may include CSI configuration information for one or more channel measurement resources 410 (e.g., that are associated with self-interference measurements), one or more self-interference measurement resources 415, one or more self-interference CSI metrics 440 (e.g., report Quantity in CSI-ReportConfig IE), or any combination thereof. In some examples, the CSI configuration 405 may be included in the control information 240, and the one or more self-interference CSI metrics 440 may be reported in the self-interference CSI report 245 as described with reference to FIG. 2. For example, a UE 115-a may receive the CSI configuration 405 (e.g., via control signaling in the downlink communication link 205) from a network entity 105-a, and the UE 115-a may transmit the one or more self-interference CSI metrics 440 (e.g., via a CSI report in the uplink communication link 210) to the network entity 105-a.

In some examples, the CSI configuration 405 may include control information that configures the UE 115-a (e.g., a full-duplex UE) to explicitly report (e.g., and measure) self-interference with the one or more self-interference CSI metrics 440 (e.g., report self-interference with independent self-interference metrics of SI-RSRP and SI-RSSI). For instance, the CSI configuration 405 may include self-interference measurement resources 415 (e.g., SI-Resource setting for SI measurement). Each self-interference measurement resource 415 may be associated with one or more self-interference resources sets 430 (e.g., SI-resource set Resource k). Although, a single self-interference resource set 430 is shown, each self-interference measurement resource 415 may be associated with multiple self-interference resource sets 430. Each self-interference resources set 430 may be associated with one or more resources 435 including, for example, a resource 435-a (e.g., SI-SRS resource k1) and a resource 435-b (e.g., SI-SRS resource k2). In such examples the one or more self-interference CSI metrics 440 may include associated self-interference metrics including, for example, a metric 440-a (e.g., SI-RSSI) and a metric 440-b (e.g., SI-RSRP).

Additionally, in some examples, the CSI configuration 405 may include one or more channel measurement resources 410. Each channel measurement resource 410 may be associated with one or more resources sets 420 (e.g., NZP CSI-RS resource set Resource k). Although, a single resource set 420 is shown, each channel measurement resource 410 may be associated with multiple resource sets 420. Each resources set 430 may be associated with one or more resources 425 including, for example, a resource 425-a (e.g., CSI-RS resource k1) and a resource 425-b (e.g., CLI-RSSI resource k2). In some examples, each resource 425 may be associated with one or more resources 435 (e.g., there may be a linkage for CMR and CLI IMR to one or more SI resources or a linkage for different aggressors). In some examples, the CSI configuration 405 may include both the one or more channel measurement resources 410 and the one or more self-interference measurement resources 415 (e.g., may include both NZP CSI-RS and SI-Resource) in order to measure one or more metrics 440 (e.g., self-interference-SINR (SI-SINR) for SI-SINR report). For instance, the network entity 105-a may configure channel measurements with linked self-interference measurements to measure a metric 440-c (e.g., the network entity 105-a may configure CMR with linked IMR for UE full-duplex self-interference for SI-SINR report). In some examples, the one or more self-interference measurement resources 415 may be associated with L1 measurements.

In some examples, the CSI configuration 405 may not include resources for measurements (e.g., channel measurements, other interference measurements) based on including the one or more self-interference measurement resources 415. In some examples, one or more fields (e.g., CMR fields, CSI-IM fields) of a CSI configuration 405 (e.g., of a CSI-ReportConfig IE) may be made optional (e.g., as defined by a rule of an industry standard) based on using full-duplex self-interference resources for a UE full-duplex self-interference metrics report. Additionally, or alternatively, the one or more self-interference CSI metrics 440 may be captured by one or more additional fields in a CSI configuration 405 (e.g., SI SRS or SI RSSI resource as a new dedicated SI resource to measure UE SI in CSI-ReportConfig). For instance, a first field of the CSI configuration 405 may include resources for a self-interference reference signal measurement (e.g., SI-SRS measurement) and a second field of the CSI configuration 405 may include resources for a signal strength measurement (e.g., SI-RSSI measurement).

In some examples, the one or more self-interference CSI metrics 440 may include dedicated reporting metrics (e.g., new metrics in reportQuantity of CSI-ReportConfig) for self-interference measurements (e.g., SI-RSRP and SI-RSSI and SI-SINR, metrics that are not associated with CQI). That is, the CSI configuration 405 may include metrics for UE full-duplex self-interference (e.g., as reportQuantity) that are separate from other metrics (e.g., associated with non-self-interference measurements).

FIG. 5 shows examples of CSI measurement configurations 500 that support techniques for CSI reporting in full-duplex communication modes in accordance with one or more aspects of the present disclosure. For example, a UE 115-b (e.g., an SBFD capable UE) may support one or more subband-based self-interference measurement in accordance with a CSI measurement configuration 500-a, a CSI measurement configuration 500-b, a CSI measurement configuration 500-c, or any combination thereof. Each CSI measurement configuration 500 may include one or more subbands including one or more downlink subbands 505 (e.g., downlink subbands 505-a and 505-b), one or more uplink subbands 510 (e.g., uplink subband 510-a). Although the CSI measurement configurations 500-a, 500-b, and 500-c show example time and frequency resources patterns for the full-duplex subbands, it is to be understood that the techniques herein may apply to various configurations of full-duplex subbands (e.g., any SBFD pattern, downlink subbands 505 that overlap with uplink subbands 510 in frequency, including any quantity of downlink subbands 505 and uplink subbands 510).

The UE 115-b may perform one or more measurements (e.g., a measurement 515, a measurement 520) within one or more subbands (e.g., of a channel bandwidth). Each measurement may be associated with a frequency allocation, which may be a same size as an downlink subband 505 or an uplink subband 510 (e.g., a same bandwidth size) or may be a different size (e.g., the measurement may be allocated as a sub-subband of a full-duplex subband). In some examples, the UE 115-b may perform a measurement (e.g., an inter-subband self-interference measurement) in accordance with the CSI measurement configuration 500-a, or the CSI measurement configuration 500-b, or the CSI measurement configuration 500-c, or a combination thereof based on a rule (e.g., defined by an industry standard) or based on one or more signaling mechanisms (e.g., received from a network entity 105).

In the CSI measurement configuration 500-a, the UE 115-b may perform a measurement 515 (e.g., a self-interference measurement) within one or more downlink subbands 505 (e.g., within a downlink subband 505-a and a downlink subband 505-b). In some examples, the measurement 515 may measure a first metric (e.g., RSSI, SINR, or other self-interference metrics) within a downlink subband 505. In the CSI measurement configuration 500-b, the UE 115-b may perform a measurement 520 (e.g., a self-interference measurement) within one or more uplink subbands 510 (e.g., within an uplink subband 510-a). In some examples, the measurement 520 may measure a second metric (e.g., RSRP, other self-interference metrics), which may be different from the first metric. In the CSI measurement configuration 500-c, the UE 115-b may perform the measurement 515 within one or more uplink subbands 510 (e.g., within the uplink subband 510-a), which may measure the first metric (e.g., RSSI, SINR, or other self-interference metrics) within the one or more uplink subbands 510. In some examples, to perform a measurement in an uplink subband 510, the UE 115-b may transmit an uplink signal (e.g., a reference signal) in the uplink subband 510 for UE self-interference measurement.

In some examples, a subband-based self-interference report (e.g., a self-interference CSI report 245) for the UE 115-b UE may report self-interference per downlink subband 505 or per uplink subband 510 based on a subband resource configuration (e.g., a time resource configuration and a frequency resource indication for each subband, an SBFD pattern) provided to the UE 115-b (e.g., by a network entity 105).

In some examples, the UE 115-b may support one of the CSI measurement configurations 500. In such examples, the UE 115-b may perform different types of CSI measurement (e.g., the measurement 515, the measurement 520, or some other self-interference measurement) based on a time and frequency resource configuration of the SBFD subbands. For example, (e.g., if all CSI measurement configurations 500 are used), the UE 115-b may implicitly measure (e.g., with measurements 515 and/or 520) and report self-interference associated with each downlink subband 505 and uplink subband 510 based on a subband configuration (e.g., semi-static SBFD configuration, time and/or frequency configuration, a resource configuration in a UE SBFD symbol or slot). In another example (e.g., if the CSI measurement configuration 500-b and 500-c are used), the UE 115-b may implicitly measure (e.g., with measurement 515 and/or measurement 520) and report self-interference associated with each uplink subband 510 based on the subband configuration (e.g., in a UE SBFD symbol or slot). In another example (e.g., if the CSI measurement configuration 500-a is used), the UE 115-b may implicitly measure (e.g., with measurement 515) and report each downlink subband 505 based on the subband configuration (e.g., in a UE SBFD symbol or slot). In such examples, the measurements may be performed without a specific configuration (e.g., without a specific subband configuration for the measurement in a reportConfig or in control information 240).

In another example, the UE 115-b may be configured to explicitly measure and report the subband-based self-interference measurements based on signaling received from a network entity 105 (e.g., control information 240, self-interference CSI-ReportConfig, CSI-ReportConfig, a CSI configuration 305, a CSI configuration 405, or other signaling). In such examples, the signaling may support indication of unequal or equal subband size configurations of self-interference measurement and reporting (e.g., a downlink subband 505 may be a first size (40 MHz) and an uplink subband 510 may be a second size (20 MHz)). For example, a network entity 105 may configure different subband sizes for the UE 115-b (e.g., may indicate a subband identifier with a corresponding subband size in a report configuration). In some examples, the signaling may include a bitmap to identify (e.g., indicate) one or more subbands that are to be measured (e.g., for self-interference) and reported to the network entity 105.

In some examples, the UE 115-b may support multiple of the CSI measurement configurations 500. In such examples, a network entity 105 may transmit an indication (e.g., via control information 240, CSI configuration 305, CSI configuration 405, or other signaling) of which measurement (e.g., the measurement 515, the measurement 520, or some other self-interference measurement) the UE 115-b is to perform (e.g., or which CSI measurement configuration 500 is to be used). For example, the indication may be communicated via a flag (e.g., a field in a triggering MAC-CE, a DCI, or other control information) that identifies which self-interference measurement is to be performed, which of the CSI measurement configurations 500 is to be used, or both. Alternatively, the UE 115-b may determine a self-interference measurement to perform based on a defined configuration (e.g., preconfigured based on an industry standard) or a semi-static configuration (e.g., based on a default RRC subband configuration).

In some examples, the 115-b may transmit different subband self-interference reports (e.g., different self-interference CSI reports 245) with different self-interference metrics. For instance, each self-interference measurement and report may be different per subband (e.g., per metric, per reportQuantity configuration, each subband may be measured for a different metric). In some examples, a network entity 105 may configure multiple self-interference report configurations for multiple self-interference CSI reports, each with different self-interference metrics (e.g., two self-interference report configurations including a first configuration for downlink subband RSSI measurement and a second configuration for uplink subband RSRP measurement). Alternatively, the UE 115-b may implicitly determine which self-interference metric to measure for a respective subband based on a subband resource configuration, based on a type of self-interference CSI measurement, based on a pre-configuration of metrics per subband, or a combination thereof. Alternatively, a network entity 105 may configure different subband sizes and different subband metrics for each measurement (e.g., a same reportConfig may include a subband identifier with a corresponding subband size and a corresponding metric to measure and report in the self-interference CSI report).

In some examples, the UE 115-b may reuse a first configuration (e.g., CQI or PMI configuration) to report (e.g., capture) full-duplex UE self-interference (e.g., implicitly as an additional interference, for an L1 self-interference measurement). For instance, a UE may reuse a first subband reporting configuration (e.g., indicated via control signaling from a network entity 105) including one or more non-self-interference metrics (e.g., existing metrics, PMI, CQI) to produce a second subband reporting configuration for self-interference metrics (e.g., as a rule). In a non-limiting example, to report UE self-interference (e.g., and to save overhead) the UE 115-b may reuse a PMI or CQI subband configuration to report subband based UE self-interference metrics. The UE 115-b may use such techniques, for example, if a CSI configuration does not include information associated with separate UE self-interference subband configuration (e.g., or other self-interference specific signaling from the network entity 105).

In some examples, the UE 115-b may modify a first configuration (e.g., an existing PMI or CQI subband configuration) to report full-duplex UE self-interference (e.g., if UE self-interference is captured in existing CQI report, for an L1 self-interference measurement). For instance, the UE 115-b may add a scalar value to a PMI or CQI subband configuration (e.g., a number of subband multiplied divided by an integer value, a subband size multiplied divided by an integer value) to save overhead. In such examples, a configuration for self-interference (e.g., configuration signaling by a network entity 105) may not include fields for separate self-interference subband configuration but may include a scalar value to use for the modification of the first subband resource configuration.

Alternatively, a new field (e.g., a field for a subband measurement reporting configuration) in a CSI report configuration (e.g., the control information 240, the CSI configuration 305, the CSI configuration 405) or in an IE may configure the UE 115-b for self-interference CSI measurements and reports (e.g., for an L1 self-interference measurement or a layer three (L3) measurement). For example, the new field (e.g., or some other signaling or configuration) may identity resources (e.g., time and frequency resources, a quantity) for one or more measurement subbands for performing a self-interference CSI measurement. Each of the one or more measurement subbands may be a same subband (e.g., a same frequency allocation, a same bandwidth) as a downlink subband 505 or an uplink subband 510 (e.g., SBFD subbands) or may be different from a downlink subband 505 or an uplink subband 510 (e.g., a different frequency allocation, a different bandwidth). That is, there may be one measurement subband within each downlink subband 505 or each uplink subband 510, or there may be more than one measurement subband within each downlink subband 505 or each uplink subband 510 of SBFD operation of the UE 115-b.

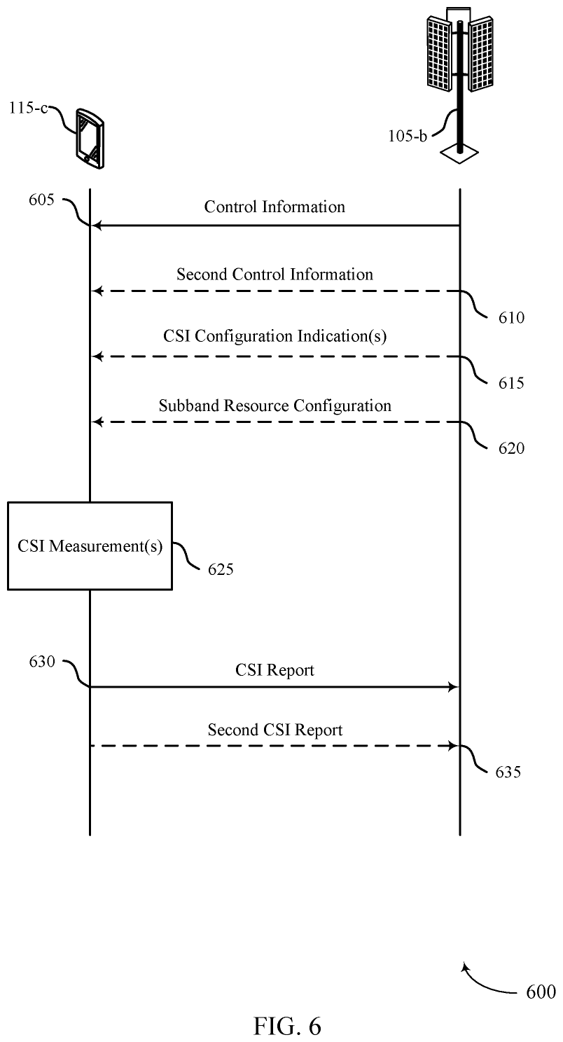

FIG. 6 shows an example of a process flow 600 that supports techniques for CSI reporting in full-duplex communication modes in accordance with one or more aspects of the present disclosure. In some examples, process flow 600 may implement aspects of the wireless communications system 100, the wireless communications system 200, the CSI configuration 305, the CSI configuration 405, and the CSI measurement configurations 500. For example, the process flow 600 may support signaling between a receiver UE 115-c and a network entity 105-b to enable measurement and reporting of self-interference (e.g., of the UE 115-c) in full-duplex communications. The UE 115-c and the network entity 105-b of the process flow 600 may be examples of corresponding devices herein, including with reference to FIGS. 1, 2, and 5.

In the following description of process flow 600, the operations between the UE 115-c and the network entity 105-b may be performed in a different order than the order shown, or other operations may be added or removed from the process flow 600. For example, some operations may also be left out of process flow 600, or may be performed in different orders or at different times. Further, although some operations or signaling may be shown to occur at different times for discussion purposes, these operations may actually occur at the same time. Although the UE 115-c and the network entity 105-b are shown performing the operations of process flow 600, some aspects of some operations may also be performed by one or more other wireless or network devices.

At 605, in some examples, the UE 115-c may receive control information (e.g., from the network entity 105-b, control signaling including a CSI configuration 305, a combined CSI-ReportConfig) that may include a first configuration for a first CSI measurement (e.g., SI-Resource setting for SI measurements) and a second configuration for a second CSI measurement (e.g., NZP CSI-RS resource setting for channel or interference measurement, CSI-RS resource setting for interference measurement), where the first CSI measurement may be associated with self-interference from full-duplex communications of the UE 115-c and the second CSI measurement may be associated with a channel measurement and interference measurements other than self-interference of the UE 115-c. In some examples, the UE 115-c may receive an indication of one or more resources for the first CSI measurement via a field of the control information that may be associated with self-interference. Alternatively, the UE 115-c may receive an indication of one or more first resources for an SRS measurement (e.g., set SI SRS resource set) via a first field of the control information, an indication of one or more second resources for an RSSI measurement (e.g., an SI RSSI resource set) via a second field of the control information, or both. In some examples, the first field and the second field may be associated with the first configuration (e.g., associated with a configuration for self-interference measurements).

Additionally, or alternatively, the UE 115-c may receive control information (e.g., from the network entity 105-b, control signaling) that may include a configuration for a self-interference measurement (e.g., a CSI configuration 405, a dedicated SI CSI-ReportConfig), where the self-interference measurement may be associated with full duplex communications of the UE 115-c (e.g., SI-Resource setting for SI measurements). In some cases, the control information may not include resources for channel measurement and may not include resources associated with interference measurements other than self-interference of the UE 115-c based on the control information being associated the self-interference measurement. In some examples, the UE 115-b may receive an indication of one or more first resources for a self-interference SRS measurement via a first field of the control information, an indication of one or more second resources for an RSSI measurement via a second field of the control information, or both, wherein the first field and the second field are associated with the configuration. In some examples, the UE 115-c may receive, via the control information, an indication of one or more resources for a channel measurement that may be associated with the self-interference measurement, where each resource of the one or more resources for the channel measurement may be associated with at least one self-interference CSI metric (e.g., indication of CMR resources that are linked to SI-RSSI resources).

Additionally, or alternatively, the UE 115-c may receive control information that identifies a configuration for a CSI measurement, where the CSI measurement may be associated with measuring self-interference of the UE 115-c in one or more subbands (e.g., downlink subbands, uplink subbands) associated with SBFD communications by the UE 115-c (e.g., self-interference reporting may be subband-based). In some examples, the UE 115-c may receive, via the control information, an indication of respective self-interference metrics that are associated with each of the one or more subbands, and the UE 115-c may transmit a report (e.g., the CSI report at 630) based on the indication. In some examples, the UE 115-c may receive, via the control information, an indication of a first subband reporting configuration associated with a PMI measurement, a CQI measurement, or both. A second subband reporting configuration for transmitting a CSI report (e.g., an self-interference CSI report) may be a same subband reporting configuration as the first subband reporting configuration. Alternatively, the UE 115-c may modify (e.g., by applying a scalar values) the first subband reporting configuration to obtain the second subband reporting configuration to transmit the CSI report (e.g., at 630). In some examples, the UE 115-c may receive, via a field of the control information, an indication of a subband measurement reporting configuration for the UE 115-c to transmit the CSI report. In some examples, the subband measurement reporting configuration (e.g., or other signaling) may identify one or more measurement subbands (e.g., frequency allocations, bandwidth sizes, a quantity of measurement subbands) for performing the channel state information measurement.

In some examples, the UE 115-c may receive, via the control information, an indication of a size for each subband (e.g., a bandwidth size for each self-interference measurement of a subband) to be measured of the one or more subbands. In some examples, the UE 115-c may perform the CSI measurements for self-interference (e.g., at 625) based on the indication. In some examples, the indication may include a bitmap that identifies the one or more subbands that are to be measured by the UE 115-c for self-interference via the CSI measurement.

In some examples, one or more uplink resources associated with the full-duplex communications may not overlap with one or more downlink resources associated with the full-duplex communications. Alternatively, one or more uplink resources associated with the full-duplex communications may at least partially overlap with one or more downlink resources associated with the full-duplex communications.

At 610, in some examples, the UE 115-c may receive second control information that may be not associated with self-interference measurements of the UE 115-c. For instance, the second control information may not include a configuration for self-interference measurements.

At 615, the UE 115-c may receive an indication that identifies that the CSI measurement for self-interference (e.g., at 625) is to be performed in accordance with a first measurement of a first metric (e.g., RSSI, SINR) within at least one downlink subband of the one or more subbands, in accordance with a second measurement of a second metric (e.g., RSRP) within at least one uplink subband of the one or more subbands, or in accordance with a third measurement of the first metric within the at least one uplink subband of the one or more subbands, or in accordance with some other measurement. In some examples, the indication may be received via a MAC-CE message, a DCI message, a RRC message, or any combination thereof.

In some examples, the UE 115-c may receive an indication via a DCI message, a MAC-CE message, a RRC message, a field of the control information, or any combination thereof, of whether the UE 115-c is to transmit a single CSI report or transmit multiple CSI report (e.g., both the CSI report at 630 and the second CSI report at 635). In some examples, the UE 115-c may transmit the second CSI report at 635 based on the indication.

At 620 (e.g., for subband-based self-interference reporting), the UE 115-c may receive a time and frequency resource configuration for one or more downlink subbands and one or more uplink subbands (e.g., an SBFD configuration). In some examples, the UE 115-c may perform a CSI measurement for self-interference (e.g., at 625) and may transmit a CSI report (e.g., at 630) based on the time and frequency resource configuration. For example, the UE 115-c may perform the CSI measurement in accordance with a measurement of a metric (e.g., RSRP) within an uplink subband or in accordance with a measurement of a different metric (e.g., RSSI) within the uplink subband based on the time and frequency resource configuration. In another example, the UE 115-c may perform the CSI measurement in accordance with a measurement of a metric (e.g., RSSI, SINR) within at least one downlink subband based on the time and frequency resource configuration. In yet another example, the UE 115-c may perform the CSI measurement in accordance with a measurement of a metric (e.g., RSSI, SINR) within at least one downlink subband and in accordance with a measurement of one or more metrics (e.g., RSRP, RSSI) within an uplink subband.

At 625, the UE 115-c may perform one or more CSI measurements. For example, the UE 115-c may perform a first CSI measurement and a second CSI measurement, where the first CSI measurement is performed in accordance with a first configuration that is associated with self-interference and the second CSI measurement is performed in accordance with a second configuration that is not associated with self-interference (e.g., associated with interference or measurements other than self-interference measurements). In some examples, the CSI measurements be associated with self-interference measurements based on receiving a dedicated self-interference CSI configuration (e.g., a CSI configuration 405). In some examples, the CSI measurement may be associated with an L1 measurement.

Additionally, or alternatively, the UE 115-c may perform the CSI measurement based on a configuration for self-interference measurements in SBFD based full-duplex communications. In such examples, the UE 115-c may perform one or more CSI measurements in accordance with a first measurement of a first metric (e.g., RSSI, SINR) within at least one downlink subband, a second measurement of a second metric (e.g., RSRP) within at least one uplink subband, a third measurement of the first metric (e.g., RSSI) within the at least one uplink subband, or any combination thereof. In some examples, a self-interference metric (e.g., RSSI, RSRP, SINR) that is associated with the CSI measurement may be based on a type of CSI measurement (e.g., based on a rule associated with a CSI measurement configuration 500 or based on a supported CSI measurement configuration 500). In some examples, the CSI measurement may be associated with an L1 measurement, an L3 measurement, or both.

At 630, the UE 115-c may transmit, based on performing the CSI measurements, a CSI report (e.g., a self-interference CSI report, a combined CSI report) including one or more CSI metrics. In some examples, each CSI metric may be associated with both of a first CSI measurement that is associated with self-interference and a second CSI measurement that is not associated with self-interference (e.g., the CSI metrics may account for both self-interference and other interference). In some examples, the CSI metrics may be associated with self-interference, a channel measurement, and one or more of inter-cell interference, MU-MIMO interference, and CLI. In some examples, the one or more CSI metrics may be associated with an identifier (e.g., each metric may be appended with “si”) that indicates that the one or more first CSI metrics are associated with self-interference. In some examples, the UE 115-c may transmit, via the CSI report, one or more second CSI metrics different from the one or more CSI metrics. For example, the one or more second CSI metrics may be associated with interference measurements other than self-interference measurements and may be included in the CSI report as separate quantities from the self-interference metrics.

Alternatively, the CSI metrics may not be associated with any non-self-interference measurements (e.g., the CSI metrics may be dedicated for self-interference). For example, the UE 115-c may transmit, based on performing self-interference CSI measurements, a dedicated self-interference CSI report including one or more dedicated self-interference CSI metrics associated with the self-interference measurement. In some examples, the one or more dedicated self-interference CSI metrics may be associated with an RSRP measurement for self-interference, an RSSI measurement for self-interference, an SINR for self-interference, or any combination thereof.

At 635, in some examples, the UE 115-c may transmit a second CSI report that may be not associated with self-interference measurements of the UE 115-c. In some examples, the UE 115-c may transmit the second CSI report based on the UE 115-c receiving second control information (e.g., at 610). Additionally, or alternatively, the CSI report at 630 and the second CSI report at 635 may report different CSI measurements that are associated with different subbands. For instance, the CSI report at 630 may be associated with a first measurement of a first metric within a downlink subband and the second CSI report at 635 may be associated with a second measurement of one or more metrics (e.g., different from the first metric, or the same as the first metric) within an uplink subband.

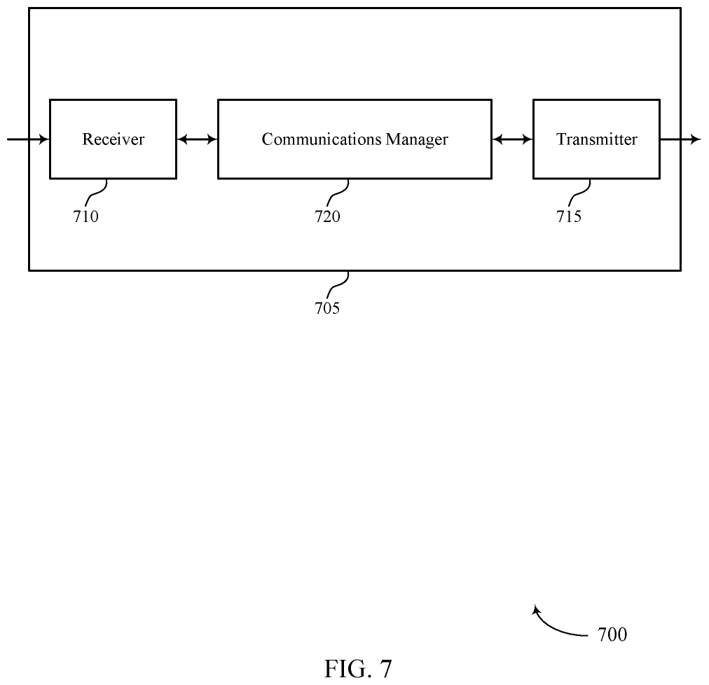

FIG. 7 shows a block diagram 700 of a device 705 that supports techniques for CSI reporting in full-duplex communication modes in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for CSI reporting in full-duplex communication modes). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for CSI reporting in full-duplex communication modes). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for CSI reporting in full-duplex communication modes as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The communications manager 720 is capable of, configured to, or operable to support a means for performing the first CSI measurement and the second CSI measurement, where the first CSI measurement is performed in accordance with the first configuration and the second CSI measurement is performed in accordance with the second configuration. The communications manager 720 is capable of, configured to, or operable to support a means for transmitting, based on the performing, a CSI report including one or more first CSI metrics, where each CSI metric of the one or more first CSI metrics is associated with both of the first CSI measurement and the second CSI measurement.

Additionally, or alternatively, the communications manager 720 may support wireless communication in accordance with examples as disclosed herein. For example, the communications manager 720 is capable of, configured to, or operable to support a means for receiving control information that includes a configuration for a self-interference measurement, where the self-interference measurement is associated with full-duplex communications of a UE. The communications manager 720 is capable of, configured to, or operable to support a means for performing the self-interference measurement in accordance with the configuration. The communications manager 720 is capable of, configured to, or operable to support a means for transmitting, based on the performing, a self-interference CSI report including one or more self-interference CSI metrics associated with the self-interference measurement.

Additionally, or alternatively, the communications manager 720 may support wireless communication in accordance with examples as disclosed herein. For example, the communications manager 720 is capable of, configured to, or operable to support a means for receiving control information that identifies a configuration for a CSI measurement, where the CSI measurement is associated with measuring self-interference of a UE in one or more subbands associated with subband full-duplex communications by the UE. The communications manager 720 is capable of, configured to, or operable to support a means for performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. The communications manager 720 is capable of, configured to, or operable to support a means for transmitting a report of the CSI measurement based on the performing.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources, among other benefits.

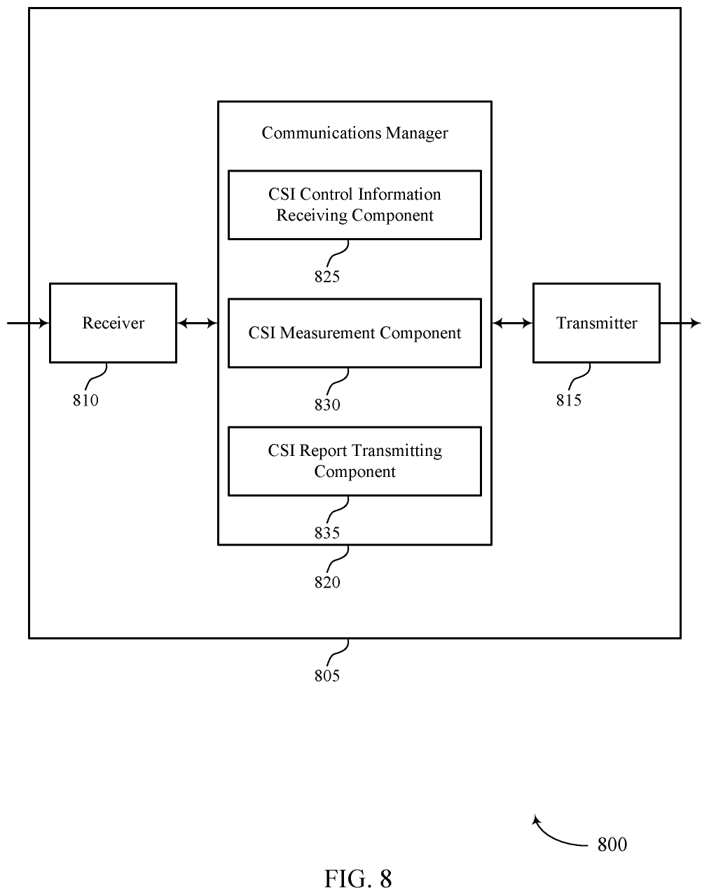

FIG. 8 shows a block diagram 800 of a device 805 that supports techniques for CSI reporting in full-duplex communication modes in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for CSI reporting in full-duplex communication modes). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for CSI reporting in full-duplex communication modes). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for CSI reporting in full-duplex communication modes as described herein. For example, the communications manager 820 may include a CSI control information receiving component 825, a CSI measurement component 830, a CSI report transmitting component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The CSI control information receiving component 825 is capable of, configured to, or operable to support a means for receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The CSI measurement component 830 is capable of, configured to, or operable to support a means for performing the first CSI measurement and the second CSI measurement, where the first CSI measurement is performed in accordance with the first configuration and the second CSI measurement is performed in accordance with the second configuration. The CSI report transmitting component 835 is capable of, configured to, or operable to support a means for transmitting, based on the performing, a CSI report including one or more first CSI metrics, where each CSI metric of the one or more first CSI metrics is associated with both of the first CSI measurement and the second CSI measurement.

Additionally, or alternatively, the communications manager 820 may support wireless communication in accordance with examples as disclosed herein. The CSI control information receiving component 825 is capable of, configured to, or operable to support a means for receiving control information that includes a configuration for a self-interference measurement, where the self-interference measurement is associated with full-duplex communications of a UE. The CSI measurement component 830 is capable of, configured to, or operable to support a means for performing the self-interference measurement in accordance with the configuration. The CSI report transmitting component 835 is capable of, configured to, or operable to support a means for transmitting, based on the performing, a self-interference CSI report including one or more self-interference CSI metrics associated with the self-interference measurement.

Additionally, or alternatively, the communications manager 820 may support wireless communication in accordance with examples as disclosed herein. The CSI control information receiving component 825 is capable of, configured to, or operable to support a means for receiving control information that identifies a configuration for a CSI measurement, where the CSI measurement is associated with measuring self-interference of a UE in one or more subbands associated with subband full-duplex communications by the UE. The CSI measurement component 830 is capable of, configured to, or operable to support a means for performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. The CSI report transmitting component 835 is capable of, configured to, or operable to support a means for transmitting a report of the CSI measurement based on the performing.

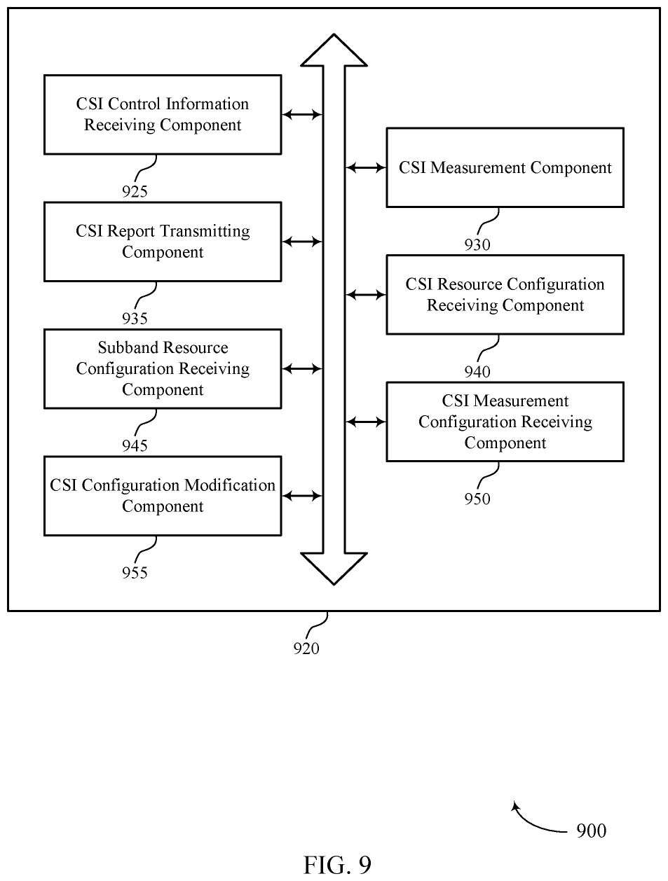

FIG. 9 shows a block diagram 900 of a communications manager 920 that supports techniques for CSI reporting in full-duplex communication modes in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for CSI reporting in full-duplex communication modes as described herein. For example, the communications manager 920 may include a CSI control information receiving component 925, a CSI measurement component 930, a CSI report transmitting component 935, a CSI resource configuration receiving component 940, a subband resource configuration receiving component 945, a CSI measurement configuration receiving component 950, a CSI configuration modification component 955, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The CSI control information receiving component 925 is capable of, configured to, or operable to support a means for receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The CSI measurement component 930 is capable of, configured to, or operable to support a means for performing the first CSI measurement and the second CSI measurement, where the first CSI measurement is performed in accordance with the first configuration and the second CSI measurement is performed in accordance with the second configuration. The CSI report transmitting component 935 is capable of, configured to, or operable to support a means for transmitting, based on the performing, a CSI report including one or more first CSI metrics, where each CSI metric of the one or more first CSI metrics is associated with both of the first CSI measurement and the second CSI measurement.

In some examples, the CSI resource configuration receiving component 940 is capable of, configured to, or operable to support a means for receiving an indication of one or more resources for the first CSI measurement via a field of the control information that is associated with self-interference.

In some examples, the CSI resource configuration receiving component 940 is capable of, configured to, or operable to support a means for receiving an indication of one or more first resources for a SRS measurement via a first field of the control information, an indication of one or more second resources for an RSSI measurement via a second field of the control information, or both, where the first field and the second field are associated with the first configuration. In some examples, the one or more first CSI metrics are associated with self-interference, a channel measurement, and one or more of inter-cell interference, MU-MIMO interference, and CLI. In some examples, the one or more first CSI metrics are associated with an identifier that indicates that the one or more first CSI metrics are associated with self-interference.

In some examples, the CSI report transmitting component 935 is capable of, configured to, or operable to support a means for transmitting a second CSI report that is not associated with self-interference measurements of the UE.

In some examples, the CSI control information receiving component 925 is capable of, configured to, or operable to support a means for receiving second control information that is not associated with self-interference measurements of the UE, where transmitting the second CSI report is based on receiving the second control information.

In some examples, the CSI control information receiving component 925 is capable of, configured to, or operable to support a means for receiving an indication via a DCI message, a MAC-CE message, a RRC message, a field of the control information, or any combination thereof, of whether the UE is to transmit the CSI report or transmit both the CSI report and the second CSI report, where transmitting the second CSI report is based on the indication.

In some examples, the CSI report transmitting component 935 is capable of, configured to, or operable to support a means for transmitting, via the CSI report, one or more second CSI metrics different from the one or more first CSI metrics, where the one or more second CSI metrics are associated with interference measurements other than self-interference measurements. In some examples, one or more uplink resources associated with the full-duplex communications do not overlap with one or more downlink resources associated with the full-duplex communications. In some examples, one or more uplink resources associated with the full-duplex communications at least partially overlap with one or more downlink resources associated with the full-duplex communications. In some examples, the first CSI measurement is associated with an L1 measurement.

Additionally, or alternatively, the communications manager 920 may support wireless communication in accordance with examples as disclosed herein. In some examples, the CSI control information receiving component 925 is capable of, configured to, or operable to support a means for receiving control information that includes a configuration for a self-interference measurement, where the self-interference measurement is associated with full-duplex communications of the UE. In some examples, the CSI measurement component 930 is capable of, configured to, or operable to support a means for performing the self-interference measurement in accordance with the configuration. In some examples, the CSI report transmitting component 935 is capable of, configured to, or operable to support a means for transmitting, based on the performing, a self-interference CSI report including one or more self-interference CSI metrics associated with the self-interference measurement.

In some examples, the control information does not include resources for channel measurement and does not include resources associated with interference measurements other than self-interference of the UE based on the control information being associated the self-interference measurement.

In some examples, the CSI resource configuration receiving component 940 is capable of, configured to, or operable to support a means for receiving an indication of one or more first resources for a self-interference SRS measurement via a first field of the control information, an indication of one or more second resources for an RSSI measurement via a second field of the control information, or both, where the first field and the second field are associated with the configuration.

In some examples, the one or more self-interference CSI metrics are associated with an RSRP measurement for self-interference, an RSSI measurement for self-interference, an SINR measurement for self-interference, or any combination thereof.

In some examples, the CSI resource configuration receiving component 940 is capable of, configured to, or operable to support a means for receiving, via the control information, an indication of one or more resources for a channel measurement that is associated with the self-interference measurement, where each resource of the one or more resources for the channel measurement is associated with at least one self-interference CSI metric. In some examples, one or more uplink resources associated with the full-duplex communications do not overlap with one or more downlink resources associated with the full-duplex communications. In some examples, one or more uplink resources associated with the full-duplex communications at least partially overlap with one or more downlink resources associated with the full-duplex communications. In some examples, the self-interference measurement is associated with an L1 measurement.

Additionally, or alternatively, the communications manager 920 may support wireless communication in accordance with examples as disclosed herein. In some examples, the CSI control information receiving component 925 is capable of, configured to, or operable to support a means for receiving control information that identifies a configuration for a CSI measurement, where the CSI measurement is associated with measuring self-interference of the UE in one or more subbands associated with subband full-duplex communications by the UE. In some examples, the CSI measurement component 930 is capable of, configured to, or operable to support a means for performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. In some examples, the CSI report transmitting component 935 is capable of, configured to, or operable to support a means for transmitting a report of the CSI measurement based on the performing.

In some examples, the subband resource configuration receiving component 945 is capable of, configured to, or operable to support a means for receiving a time and frequency resource configuration for one or more downlink subbands of the one or more subbands and one or more uplink subbands of the one or more subbands, where performing the CSI measurement and transmitting the report are based on the time and frequency resource configuration.

In some examples, the subband resource configuration receiving component 945 is capable of, configured to, or operable to support a means for receiving a time and frequency resource configuration for one or more downlink subbands of the one or more subbands and one or more uplink subbands of the one or more subbands, where the CSI measurement is performed in accordance with the second measurement or in accordance with the third measurement based on the time and frequency resource configuration.

In some examples, the subband resource configuration receiving component 945 is capable of, configured to, or operable to support a means for receiving a time and frequency resource configuration for one or more downlink subbands of the one or more subbands and one or more uplink subbands of the one or more subbands, where the CSI measurement is performed in accordance with the first measurement based on the time and frequency resource configuration.

In some examples, the subband resource configuration receiving component 945 is capable of, configured to, or operable to support a means for receiving a time and frequency resource configuration for one or more downlink subbands of the one or more subbands and one or more uplink subbands of the one or more subbands, where the CSI measurement is performed in accordance with the first measurement and in accordance with the second measurement or the third measurement based on the time and frequency resource configuration.

In some examples, the subband resource configuration receiving component 945 is capable of, configured to, or operable to support a means for receiving, via the control information, an indication of a size for each subband to be measured of the one or more subbands, where performing the CSI measurement is based on the indication. In some examples, the indication includes a bitmap that identifies the one or more subbands that are to be measured for self-interference via the CSI measurement.

In some examples, the CSI measurement configuration receiving component 950 is capable of, configured to, or operable to support a means for receiving an indication that identifies that the CSI measurement is to be performed in accordance with the first measurement, with the second measurement, or with the third measurement. In some examples, the indication is received via a MAC-CE message, a DCI message, a RRC message, or any combination thereof.

In some examples, the CSI report transmitting component 935 is capable of, configured to, or operable to support a means for transmitting a second report of second CSI measurement, where the report is associated with the first measurement and the second report is associated with the second measurement or the third measurement. In some examples, a self-interference metric associated with the CSI measurement is based on a type of CSI measurement.

In some examples, the CSI control information receiving component 925 is capable of, configured to, or operable to support a means for receiving, via the control information, an indication of respective self-interference metrics that are associated with each of the one or more subbands, where transmitting the report is based on the indication.

In some examples, the CSI control information receiving component 925 is capable of, configured to, or operable to support a means for receiving, via the control information, an indication of a first subband reporting configuration associated with a PMI measurement, a CQI measurement, or both, where a second subband reporting configuration for transmitting the report is a same subband reporting configuration as the first subband reporting configuration.

In some examples, the CSI control information receiving component 925 is capable of, configured to, or operable to support a means for receiving, via the control information, an indication of a first subband reporting configuration associated with a PMI measurement, a CQI measurement, or both. In some examples, the CSI configuration modification component 955 is capable of, configured to, or operable to support a means for modifying the first subband reporting configuration to obtain a second subband reporting configuration for transmitting the report.

In some examples, the CSI control information receiving component 925 is capable of, configured to, or operable to support a means for receiving, via a field of the control information, an indication of a subband measurement reporting configuration for transmitting the report, where the subband measurement reporting configuration identifies one or more measurement subbands for performing the channel state information measurement. In some examples, the CSI measurement is associated with an L1 measurement, an L3 measurement, or both.

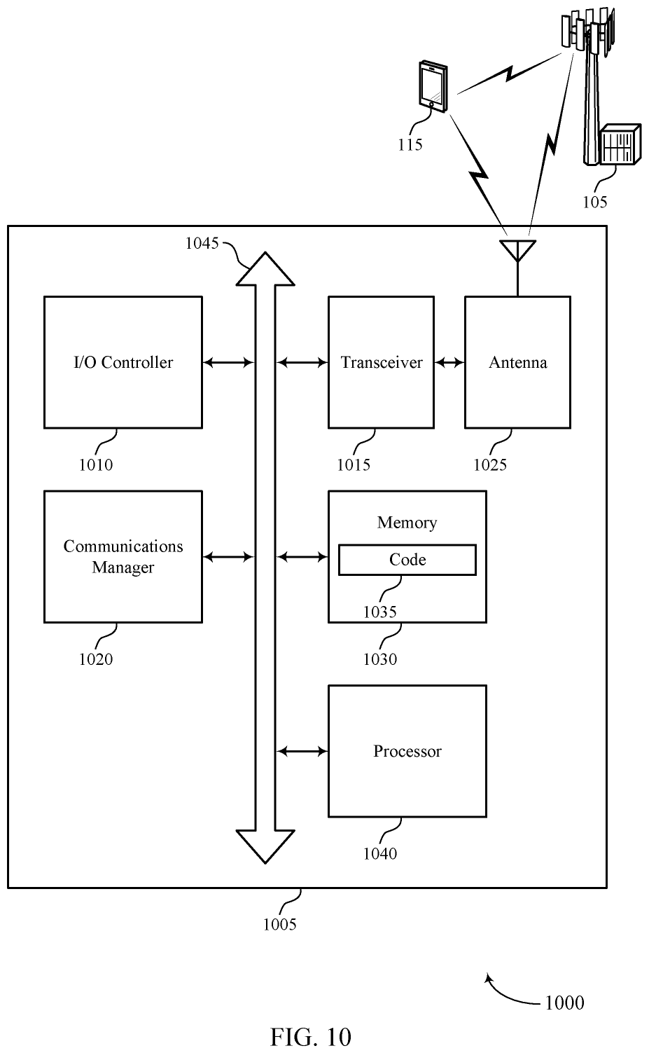

FIG. 10 shows a diagram of a system 1000 including a device 1005 that supports techniques for CSI reporting in full-duplex communication modes in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a basic I/O system (BIOS) which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting techniques for CSI reporting in full-duplex communication modes). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. As such, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The communications manager 1020 is capable of, configured to, or operable to support a means for performing the first CSI measurement and the second CSI measurement, where the first CSI measurement is performed in accordance with the first configuration and the second CSI measurement is performed in accordance with the second configuration. The communications manager 1020 is capable of, configured to, or operable to support a means for transmitting, based on the performing, a CSI report including one or more first CSI metrics, where each CSI metric of the one or more first CSI metrics is associated with both of the first CSI measurement and the second CSI measurement.

Additionally, or alternatively, the communications manager 1020 may support wireless communication in accordance with examples as disclosed herein. For example, the communications manager 1020 is capable of, configured to, or operable to support a means for receiving control information that includes a configuration for a self-interference measurement, where the self-interference measurement is associated with full-duplex communications of a UE. The communications manager 1020 is capable of, configured to, or operable to support a means for performing the self-interference measurement in accordance with the configuration. The communications manager 1020 is capable of, configured to, or operable to support a means for transmitting, based on the performing, a self-interference CSI report including one or more self-interference CSI metrics associated with the self-interference measurement.

Additionally, or alternatively, the communications manager 1020 may support wireless communication in accordance with examples as disclosed herein. For example, the communications manager 1020 is capable of, configured to, or operable to support a means for receiving control information that identifies a configuration for a CSI measurement, where the CSI measurement is associated with measuring self-interference of a UE in one or more subbands associated with subband full-duplex communications by the UE. The communications manager 1020 is capable of, configured to, or operable to support a means for performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. The communications manager 1020 is capable of, configured to, or operable to support a means for transmitting a report of the CSI measurement based on the performing.

By including or configuring the communications manager 1020 in accordance with examples as described herein, the device 1005 may support techniques for improved communication reliability, reduced latency, more efficient utilization of communication resources, improved coordination between devices, and improved utilization of processing capability, among other benefits.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of techniques for CSI reporting in full-duplex communication modes as described herein, or the at least one processor 1040 and the at least one memory 1030 may be otherwise configured to, individually or collectively, perform or support such operations.

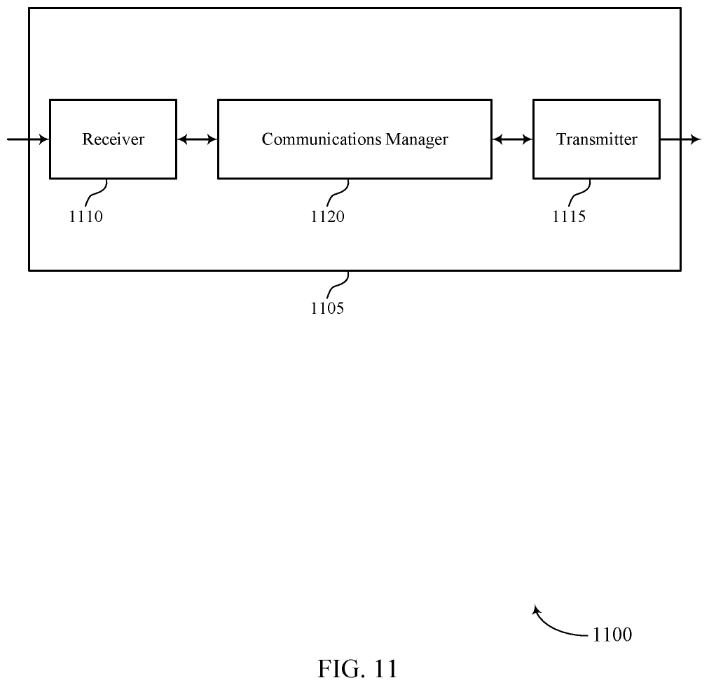

FIG. 11 shows a block diagram 1100 of a device 1105 that supports techniques for CSI reporting in full-duplex communication modes in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of techniques for CSI reporting in full-duplex communication modes as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor. If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The communications manager 1120 is capable of, configured to, or operable to support a means for receiving, based on transmitting the control information, a CSI report including one or more first CSI metrics, where each CSI metric of the one or more first CSI metrics is associated with both of the first CSI measurement and the second CSI measurement.

Additionally, or alternatively, the communications manager 1120 may support wireless communication in accordance with examples as disclosed herein. For example, the communications manager 1120 is capable of, configured to, or operable to support a means for transmitting control information that includes a configuration for a self-interference measurement, where the self-interference measurement is associated with full-duplex communications of a UE. The communications manager 1120 is capable of, configured to, or operable to support a means for receiving, based on transmitting the control information, a self-interference CSI report including one or more self-interference CSI metrics associated with the self-interference measurement.

Additionally, or alternatively, the communications manager 1120 may support wireless communication in accordance with examples as disclosed herein. For example, the communications manager 1120 is capable of, configured to, or operable to support a means for transmitting control information that identifies a configuration for a CSI measurement, where the CSI measurement is associated with measuring self-interference of a UE in one or more subbands associated with subband full-duplex communications by the UE. The communications manager 1120 is capable of, configured to, or operable to support a means for receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for more efficient utilization of communication resources, among other benefits.

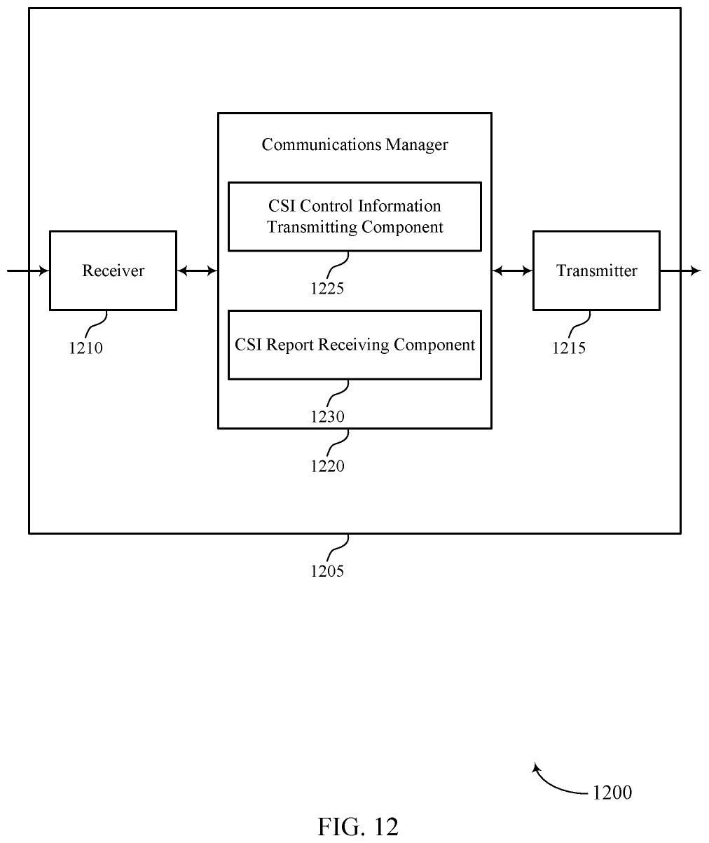

FIG. 12 shows a block diagram 1200 of a device 1205 that supports techniques for CSI reporting in full-duplex communication modes in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, and the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of techniques for CSI reporting in full-duplex communication modes as described herein. For example, the communications manager 1220 may include a CSI control information transmitting component 1225 a CSI report receiving component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The CSI control information transmitting component 1225 is capable of, configured to, or operable to support a means for transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The CSI report receiving component 1230 is capable of, configured to, or operable to support a means for receiving, based on transmitting the control information, a CSI report including one or more first CSI metrics, where each CSI metric of the one or more first CSI metrics is associated with both of the first CSI measurement and the second CSI measurement.

Additionally, or alternatively, the communications manager 1220 may support wireless communication in accordance with examples as disclosed herein. The CSI control information transmitting component 1225 is capable of, configured to, or operable to support a means for transmitting control information that includes a configuration for a self-interference measurement, where the self-interference measurement is associated with full-duplex communications of a UE. The CSI report receiving component 1230 is capable of, configured to, or operable to support a means for receiving, based on transmitting the control information, a self-interference CSI report including one or more self-interference CSI metrics associated with the self-interference measurement.

Additionally, or alternatively, the communications manager 1220 may support wireless communication in accordance with examples as disclosed herein. The CSI control information transmitting component 1225 is capable of, configured to, or operable to support a means for transmitting control information that identifies a configuration for a CSI measurement, where the CSI measurement is associated with measuring self-interference of a UE in one or more subbands associated with subband full-duplex communications by the UE. The CSI report receiving component 1230 is capable of, configured to, or operable to support a means for receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

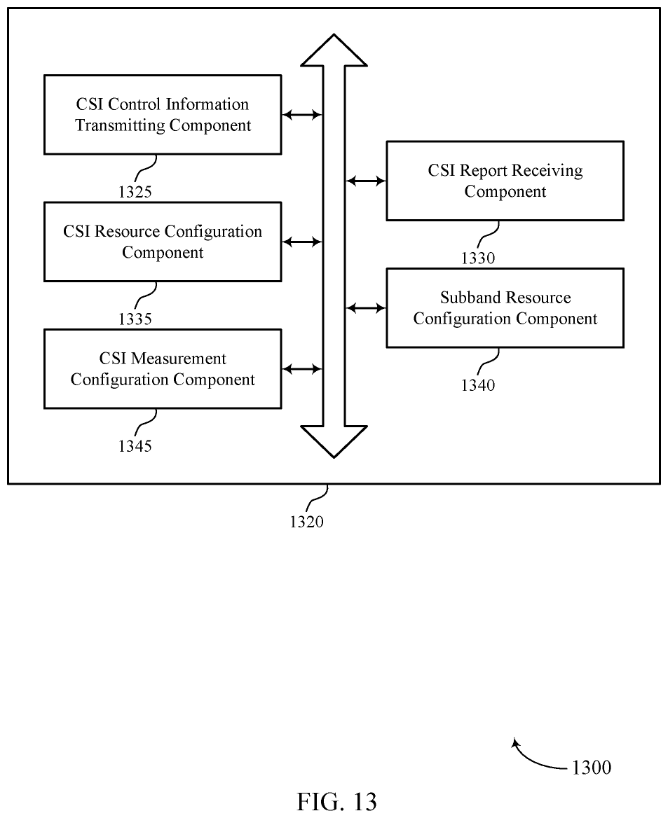

FIG. 13 shows a block diagram 1300 of a communications manager 1320 that supports techniques for CSI reporting in full-duplex communication modes in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of techniques for CSI reporting in full-duplex communication modes as described herein. For example, the communications manager 1320 may include a CSI control information transmitting component 1325, a CSI report receiving component 1330, a CSI resource configuration component 1335, a subband resource configuration component 1340, a CSI measurement configuration component 1345, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The CSI control information transmitting component 1325 is capable of, configured to, or operable to support a means for transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The CSI report receiving component 1330 is capable of, configured to, or operable to support a means for receiving, based on transmitting the control information, a CSI report including one or more first CSI metrics, where each CSI metric of the one or more first CSI metrics is associated with both of the first CSI measurement and the second CSI measurement.

In some examples, the CSI resource configuration component 1335 is capable of, configured to, or operable to support a means for transmitting an indication of one or more resources for the first CSI measurement via a field of the control information that is associated with self-interference.

In some examples, the CSI resource configuration component 1335 is capable of, configured to, or operable to support a means for transmitting an indication of one or more first resources for a SRS measurement via a first field of the control information, an indication of one or more second resources for an RSSI measurement via a second field of the control information, or both, where the first field and the second field are associated with the first configuration. In some examples, the one or more first CSI metrics are associated with self-interference, a channel measurement, and one or more of inter-cell interference, MU-MIMO interference, and CLI. In some examples, the one or more first CSI metrics are associated with an identifier that indicates that the one or more first CSI metrics are associated with self-interference.

In some examples, the CSI report receiving component 1330 is capable of, configured to, or operable to support a means for receiving a second CSI report that is not associated with self-interference measurements of the UE.

In some examples, the CSI control information transmitting component 1325 is capable of, configured to, or operable to support a means for transmitting second control information that is not associated with self-interference measurements of the UE, where transmitting the second CSI report is based on receiving the second control information.

In some examples, the CSI control information transmitting component 1325 is capable of, configured to, or operable to support a means for transmitting an indication via a DCI message, a MAC-CE message, a RRC message, a field of the control information, or any combination thereof, of whether the UE is to transmit the CSI report or transmit both the CSI report and the second CSI report, where receiving the second CSI report is based on the indication.

In some examples, the CSI report receiving component 1330 is capable of, configured to, or operable to support a means for receiving, via the CSI report, one or more second CSI metrics different from the one or more first CSI metrics, where the one or more second CSI metrics are associated with interference measurements other than self-interference measurements. In some examples, one or more uplink resources associated with the full-duplex communications do not overlap with one or more downlink resources associated with the full-duplex communications. In some examples, one or more uplink resources associated with the full-duplex communications at least partially overlap with one or more downlink resources associated with the full-duplex communications. In some examples, the first CSI measurement is associated with an L1 measurement.

Additionally, or alternatively, the communications manager 1320 may support wireless communication in accordance with examples as disclosed herein. In some examples, the CSI control information transmitting component 1325 is capable of, configured to, or operable to support a means for transmitting control information that includes a configuration for a self-interference measurement, where the self-interference measurement is associated with full-duplex communications of a UE. In some examples, the CSI report receiving component 1330 is capable of, configured to, or operable to support a means for receiving, based on transmitting the control information, a self-interference CSI report including one or more self-interference CSI metrics associated with the self-interference measurement.

In some examples, the control information does not include resources for channel measurement and does not include resources associated with interference measurements other than self-interference of the UE based on the control information being associated the self-interference measurement.

In some examples, the CSI resource configuration component 1335 is capable of, configured to, or operable to support a means for transmitting an indication of one or more first resources for a self-interference SRS measurement via a first field of the control information, an indication of one or more second resources for an RSSI measurement via a second field of the control information, or both, where the first field and the second field are associated with the configuration.

In some examples, the one or more self-interference CSI metrics are associated with an RSRP measurement for self-interference, an RSSI measurement for self-interference, an SINR measurement for self-interference, or any combination thereof.

In some examples, the CSI resource configuration component 1335 is capable of, configured to, or operable to support a means for transmitting, via the control information, an indication of one or more resources for a channel measurement that is associated with the self-interference measurement, where each resource of the one or more resources for the channel measurement is associated with at least one self-interference CSI metric. In some examples, one or more uplink resources associated with the full-duplex communications do not overlap with one or more downlink resources associated with the full-duplex communications. In some examples, one or more uplink resources associated with the full-duplex communications at least partially overlap with one or more downlink resources associated with the full-duplex communications. In some examples, the self-interference measurement is associated with an L1 measurement.

Additionally, or alternatively, the communications manager 1320 may support wireless communication in accordance with examples as disclosed herein. In some examples, the CSI control information transmitting component 1325 is capable of, configured to, or operable to support a means for transmitting control information that identifies a configuration for a CSI measurement, where the CSI measurement is associated with measuring self-interference of a UE in one or more subbands associated with subband full-duplex communications by the UE. In some examples, the CSI report receiving component 1330 is capable of, configured to, or operable to support a means for receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

In some examples, the subband resource configuration component 1340 is capable of, configured to, or operable to support a means for transmitting a time and frequency resource configuration for one or more downlink subbands of the one or more subbands and one or more uplink subbands of the one or more subbands, where receiving the report is based on the time and frequency resource configuration.

In some examples, the subband resource configuration component 1340 is capable of, configured to, or operable to support a means for transmitting a time and frequency resource configuration for one or more downlink subbands of the one or more subbands and one or more uplink subbands of the one or more subbands, where the CSI measurement is performed by the UE in accordance with the second measurement or in accordance with the third measurement based on the time and frequency resource configuration.

In some examples, the subband resource configuration component 1340 is capable of, configured to, or operable to support a means for transmitting a time and frequency resource configuration for one or more downlink subbands of the one or more subbands and one or more uplink subbands of the one or more subbands, where the CSI measurement is performed by the UE in accordance with the first measurement based on the time and frequency resource configuration.

In some examples, the subband resource configuration component 1340 is capable of, configured to, or operable to support a means for transmitting a time and frequency resource configuration for one or more downlink subbands of the one or more subbands and one or more uplink subbands of the one or more subbands, where the CSI measurement is performed by the UE in accordance with the first measurement and in accordance with the second measurement or the third measurement based on the time and frequency resource configuration.

In some examples, the subband resource configuration component 1340 is capable of, configured to, or operable to support a means for transmitting, via the control information, an indication of a size for each subband to be measured of the one or more subbands, where receiving the report is based on transmitting the indication.

In some examples, the indication includes a bitmap that identifies the one or more subbands that are to be measured for self-interference via the CSI measurement.

In some examples, the CSI measurement configuration component 1345 is capable of, configured to, or operable to support a means for transmitting an indication that identifies that the CSI measurement is to be performed in accordance with the first measurement, with the second measurement, or with the third measurement. In some examples, the indication is received via a MAC-CE message, a DCI message, a RRC message, or any combination thereof.

In some examples, the CSI report receiving component 1330 is capable of, configured to, or operable to support a means for receiving a second report of second CSI measurement, where the report is associated with the first measurement and the second report is associated with the second measurement or the third measurement. In some examples, a self-interference metric associated with the CSI measurement is based on a type of CSI measurement.

In some examples, the CSI control information transmitting component 1325 is capable of, configured to, or operable to support a means for transmitting, via the control information, an indication of respective self-interference metrics that are associated with each of the one or more subbands, where receiving the report is based on the indication.

In some examples, the CSI control information transmitting component 1325 is capable of, configured to, or operable to support a means for transmitting, via the control information, a first subband reporting configuration associated with a PMI measurement, a CQI measurement, or both, where a second subband reporting configuration for transmitting the report is a same subband reporting configuration as the first subband reporting configuration.

In some examples, the CSI control information transmitting component 1325 is capable of, configured to, or operable to support a means for transmitting, an indication of a first subband reporting configuration associated with a PMI measurement, a CQI measurement, or both, where the report is received in accordance with a second subband reporting configuration based on transmitting the indication, and where the second subband reporting configuration is a modified version of the first subband reporting configuration.

In some examples, the CSI control information transmitting component 1325 is capable of, configured to, or operable to support a means for transmitting, via a field of the control information, an indication of a subband measurement reporting configuration for transmitting the report, where the subband measurement reporting configuration identifies one or more measurement subbands for performing the channel state information measurement. In some examples, the CSI measurement is associated with an L1 measurement, an L3 measurement, or both.

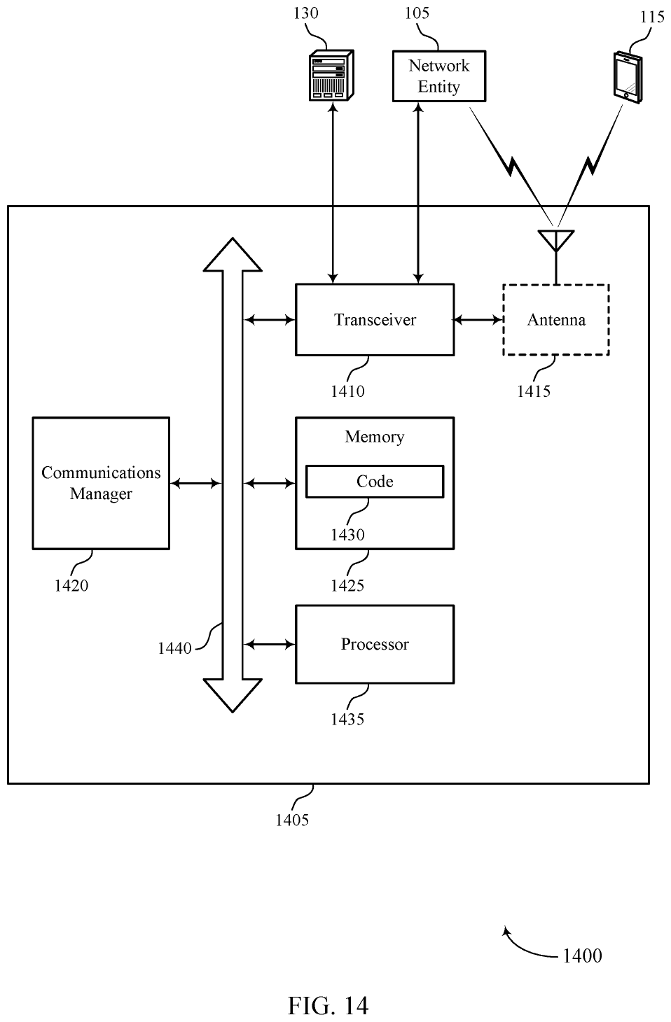

FIG. 14 shows a diagram of a system 1400 including a device 1405 that supports techniques for CSI reporting in full-duplex communication modes in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., a communication link 125, a backhaul communication link 120, a midhaul communication link 162, a fronthaul communication link 168).

The at least one memory 1425 may include RAM, ROM, or any combination thereof. The at least one memory 1425 may store computer-readable, computer-executable code 1430 including instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may contain, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting techniques for CSI reporting in full-duplex communication modes). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425). In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. As such, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The communications manager 1420 is capable of, configured to, or operable to support a means for receiving, based on transmitting the control information, a CSI report including one or more first CSI metrics, where each CSI metric of the one or more first CSI metrics is associated with both of the first CSI measurement and the second CSI measurement.

Additionally, or alternatively, the communications manager 1420 may support wireless communication in accordance with examples as disclosed herein. For example, the communications manager 1420 is capable of, configured to, or operable to support a means for transmitting control information that includes a configuration for a self-interference measurement, where the self-interference measurement is associated with full-duplex communications of a UE. The communications manager 1420 is capable of, configured to, or operable to support a means for receiving, based on transmitting the control information, a self-interference CSI report including one or more self-interference CSI metrics associated with the self-interference measurement.

Additionally, or alternatively, the communications manager 1420 may support wireless communication in accordance with examples as disclosed herein. For example, the communications manager 1420 is capable of, configured to, or operable to support a means for transmitting control information that identifies a configuration for a CSI measurement, where the CSI measurement is associated with measuring self-interference of a UE in one or more subbands associated with subband full-duplex communications by the UE. The communications manager 1420 is capable of, configured to, or operable to support a means for receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

By including or configuring the communications manager 1420 in accordance with examples as described herein, the device 1405 may support techniques for improved communication reliability, reduced latency, more efficient utilization of communication resources, improved coordination between devices, and improved utilization of processing capability, among other benefits.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of techniques for CSI reporting in full-duplex communication modes as described herein, or the at least one processor 1435 and the at least one memory 1425 may be otherwise configured to, individually or collectively, perform or support such operations.

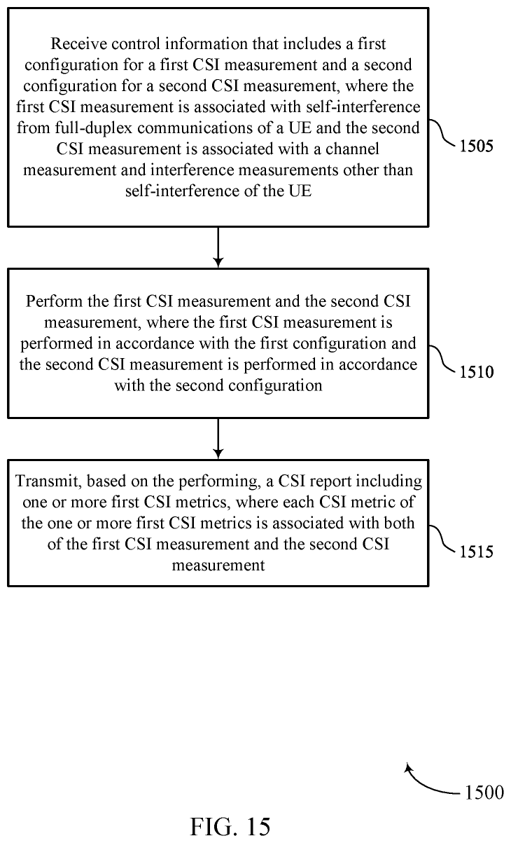

FIG. 15 shows a flowchart illustrating a method 1500 that supports techniques for CSI reporting in full-duplex communication modes in accordance with aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The operations of block 1505 may be performed in accordance with examples as disclosed herein. In some examples, aspects of the operations of 1505 may be performed by a CSI control information receiving component 925 as described with reference to FIG. 9.

At 1510, the method may include performing the first CSI measurement and the second CSI measurement, where the first CSI measurement is performed in accordance with the first configuration and the second CSI measurement is performed in accordance with the second configuration. The operations of block 1510 may be performed in accordance with examples as disclosed herein. In some examples, aspects of the operations of 1510 may be performed by a CSI measurement component 930 as described with reference to FIG. 9.

At 1515, the method may include transmitting, based on the performing, a CSI report including one or more first CSI metrics, where each CSI metric of the one or more first CSI metrics is associated with both of the first CSI measurement and the second CSI measurement. The operations of block 1515 may be performed in accordance with examples as disclosed herein. In some examples, aspects of the operations of 1515 may be performed by a CSI report transmitting component 935 as described with reference to FIG. 9.

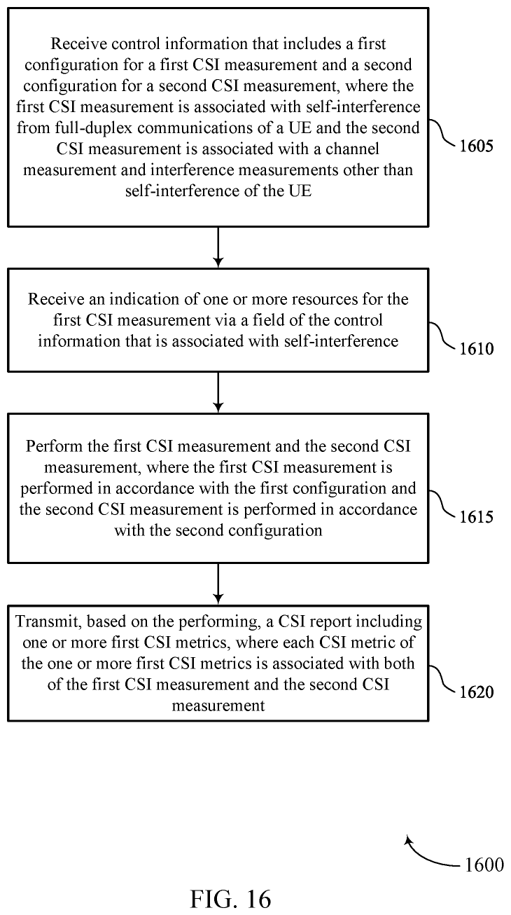

FIG. 16 shows a flowchart illustrating a method 1600 that supports techniques for CSI reporting in full-duplex communication modes in accordance with aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The operations of block 1605 may be performed in accordance with examples as disclosed herein. In some examples, aspects of the operations of 1605 may be performed by a CSI control information receiving component 925 as described with reference to FIG. 9.

At 1610, the method may include receiving an indication of one or more resources for the first CSI measurement via a field of the control information that is associated with self-interference. The operations of block 1610 may be performed in accordance with examples as disclosed herein. In some examples, aspects of the operations of 1610 may be performed by a CSI resource configuration receiving component 940 as described with reference to FIG. 9.

At 1615, the method may include performing the first CSI measurement and the second CSI measurement, where the first CSI measurement is performed in accordance with the first configuration and the second CSI measurement is performed in accordance with the second configuration. The operations of block 1615 may be performed in accordance with examples as disclosed herein. In some examples, aspects of the operations of 1615 may be performed by a CSI measurement component 930 as described with reference to FIG. 9.

At 1620, the method may include transmitting, based on the performing, a CSI report including one or more first CSI metrics, where each CSI metric of the one or more first CSI metrics is associated with both of the first CSI measurement and the second CSI measurement. The operations of block 1620 may be performed in accordance with examples as disclosed herein. In some examples, aspects of the operations of 1620 may be performed by a CSI report transmitting component 935 as described with reference to FIG. 9.

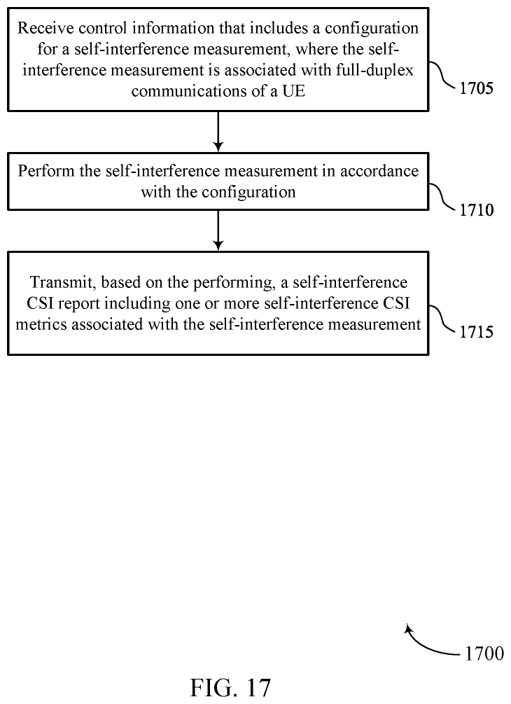

FIG. 17 shows a flowchart illustrating a method 1700 that supports techniques for CSI reporting in full-duplex communication modes in accordance with aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving control information that includes a configuration for a self-interference measurement, where the self-interference measurement is associated with full-duplex communications of a UE. The operations of block 1705 may be performed in accordance with examples as disclosed herein. In some examples, aspects of the operations of 1705 may be performed by a CSI control information receiving component 925 as described with reference to FIG. 9.

At 1710, the method may include performing the self-interference measurement in accordance with the configuration. The operations of block 1710 may be performed in accordance with examples as disclosed herein. In some examples, aspects of the operations of 1710 may be performed by a CSI measurement component 930 as described with reference to FIG. 9.

At 1715, the method may include transmitting, based on the performing, a self-interference CSI report including one or more self-interference CSI metrics associated with the self-interference measurement. The operations of block 1715 may be performed in accordance with examples as disclosed herein. In some examples, aspects of the operations of 1715 may be performed by a CSI report transmitting component 935 as described with reference to FIG. 9.

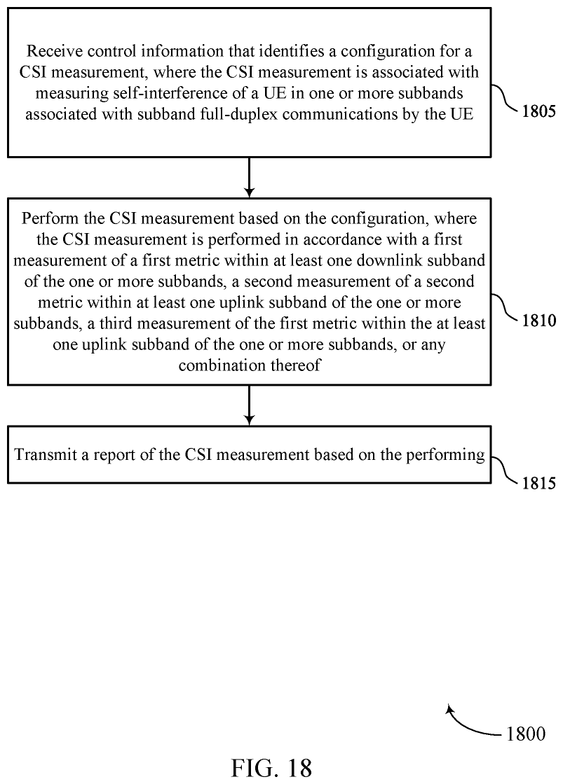

FIG. 18 shows a flowchart illustrating a method 1800 that supports techniques for CSI reporting in full-duplex communication modes in accordance with aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving control information that identifies a configuration for a CSI measurement, where the CSI measurement is associated with measuring self-interference of a UE in one or more subbands associated with subband full-duplex communications by the UE. The operations of block 1805 may be performed in accordance with examples as disclosed herein. In some examples, aspects of the operations of 1805 may be performed by a CSI control information receiving component 925 as described with reference to FIG. 9.

At 1810, the method may include performing the CSI measurement based on the configuration, where the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. The operations of block 1810 may be performed in accordance with examples as disclosed herein. In some examples, aspects of the operations of 1810 may be performed by a CSI measurement component 930 as described with reference to FIG. 9.

At 1815, the method may include transmitting a report of the CSI measurement based on the performing. The operations of block 1815 may be performed in accordance with examples as disclosed herein. In some examples, aspects of the operations of 1815 may be performed by a CSI report transmitting component 935 as described with reference to FIG. 9.

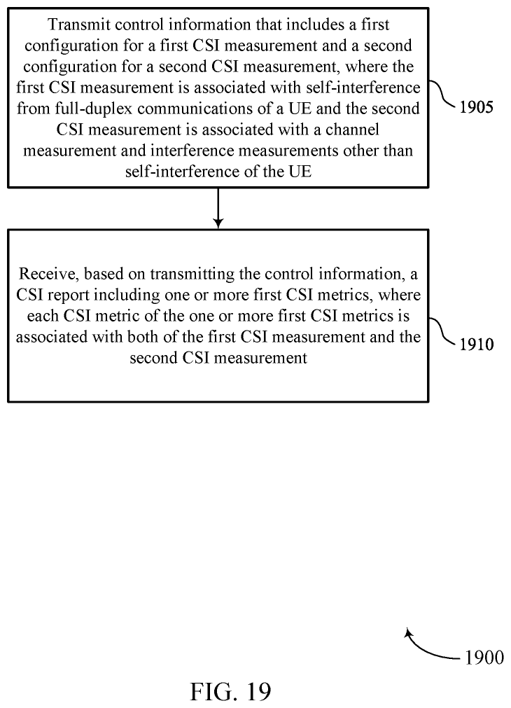

FIG. 19 shows a flowchart illustrating a method 1900 that supports techniques for CSI reporting in full-duplex communication modes in accordance with aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include transmitting control information that includes a first configuration for a first CSI measurement and a second configuration for a second CSI measurement, where the first CSI measurement is associated with self-interference from full-duplex communications of a UE and the second CSI measurement is associated with a channel measurement and interference measurements other than self-interference of the UE. The operations of block 1905 may be performed in accordance with examples as disclosed herein. In some examples, aspects of the operations of 1905 may be performed by a CSI control information transmitting component 1325 as described with reference to FIG. 13.

At 1910, the method may include receiving, based on transmitting the control information, a CSI report including one or more first CSI metrics, where each CSI metric of the one or more first CSI metrics is associated with both of the first CSI measurement and the second CSI measurement. The operations of block 1910 may be performed in accordance with examples as disclosed herein. In some examples, aspects of the operations of 1910 may be performed by a CSI report receiving component 1330 as described with reference to FIG. 13.

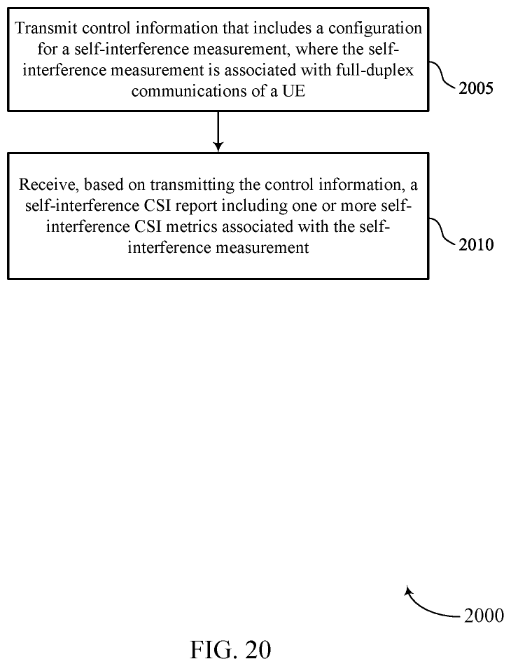

FIG. 20 shows a flowchart illustrating a method 2000 that supports techniques for CSI reporting in full-duplex communication modes in accordance with aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include transmitting control information that includes a configuration for a self-interference measurement, where the self-interference measurement is associated with full-duplex communications of a UE. The operations of block 2005 may be performed in accordance with examples as disclosed herein. In some examples, aspects of the operations of 2005 may be performed by a CSI control information transmitting component 1325 as described with reference to FIG. 13.

At 2010, the method may include receiving, based on transmitting the control information, a self-interference CSI report including one or more self-interference CSI metrics associated with the self-interference measurement. The operations of block 2010 may be performed in accordance with examples as disclosed herein. In some examples, aspects of the operations of 2010 may be performed by a CSI report receiving component 1330 as described with reference to FIG. 13.

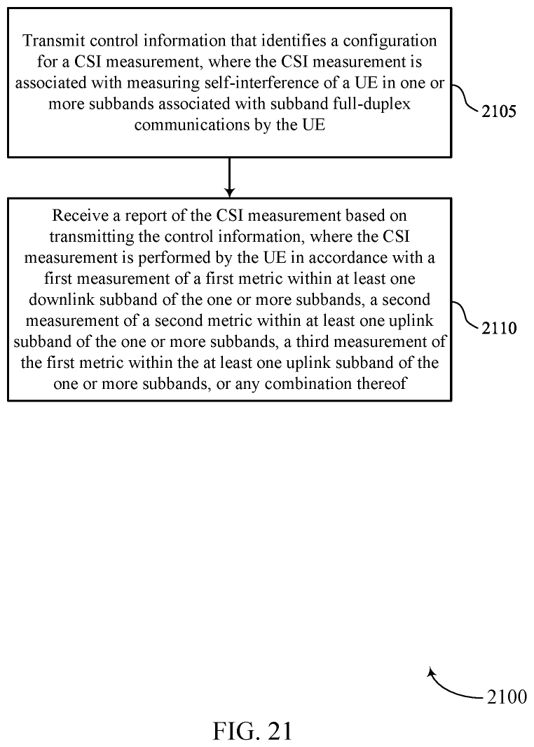

FIG. 21 shows a flowchart illustrating a method 2100 that supports techniques for CSI reporting in full-duplex communication modes in accordance with aspects of the present disclosure. The operations of the method 2100 may be implemented by a network entity or its components as described herein. For example, the operations of the method 2100 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2105, the method may include transmitting control information that identifies a configuration for a CSI measurement, where the CSI measurement is associated with measuring self-interference of a UE in one or more subbands associated with subband full-duplex communications by the UE. The operations of block 2105 may be performed in accordance with examples as disclosed herein. In some examples, aspects of the operations of 2105 may be performed by a CSI control information transmitting component 1325 as described with reference to FIG. 13.

At 2110, the method may include receiving a report of the CSI measurement based on transmitting the control information, where the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof. The operations of block 2110 may be performed in accordance with examples as disclosed herein. In some examples, aspects of the operations of 2110 may be performed by a CSI report receiving component 1330 as described with reference to FIG. 13.

The following provides an overview of aspects of the present disclosure:

Aspect 1: A method for wireless communication by a UE, comprising: receiving control information that comprises a first configuration for a first CSI measurement and a second configuration for a second CSI measurement, wherein the first CSI measurement is associated with self-interference from full-duplex communications of the UE and the second CSI measurement is associated with a channel measurement and interference measurements other than self-interference of the UE; performing the first CSI measurement and the second CSI measurement, wherein the first CSI measurement is performed in accordance with the first configuration and the second CSI measurement is performed in accordance with the second configuration; and transmitting, based at least in part on the performing, a CSI report comprising one or more first CSI metrics, wherein each CSI metric of the one or more first CSI metrics is associated with both of the first CSI measurement and the second CSI measurement.

Aspect 2: The method of aspect 1, further comprising: receiving an indication of one or more resources for the first CSI measurement via a field of the control information that is associated with self-interference.

Aspect 3: The method of aspect 1, further comprising: receiving an indication of one or more first resources for a SRS measurement via a first field of the control information, an indication of one or more second resources for an RSSI measurement via a second field of the control information, or both, wherein the first field and the second field are associated with the first configuration.

Aspect 4: The method of any of aspects 1 through 3, wherein the one or more first CSI metrics are associated with self-interference, a channel measurement, and one or more of inter-cell interference, MU-MIMO interference, and CLI.

Aspect 5: The method of any of aspects 1 through 4, wherein the one or more first CSI metrics are associated with an identifier that indicates that the one or more first CSI metrics are associated with self-interference.

Aspect 6: The method of any of aspects 1 through 5, further comprising: transmitting a second CSI report that is not associated with self-interference measurements of the UE.

Aspect 7: The method of aspect 6, further comprising: receiving second control information that is not associated with self-interference measurements of the UE, wherein transmitting the second CSI report is based at least in part on receiving the second control information.

Aspect 8: The method of any of aspects 6 through 7, further comprising: receiving an indication via a DCI message, a MAC-CE message, an RRC message, a field of the control information, or any combination thereof, of whether the UE is to transmit the CSI report or transmit both the CSI report and the second CSI report, wherein transmitting the second CSI report is based at least in part on the indication.

Aspect 9: The method of any of aspects 1 through 8, further comprising: transmitting, via the CSI report, one or more second CSI metrics different from the one or more first CSI metrics, wherein the one or more second CSI metrics are associated with interference measurements other than self-interference measurements.

Aspect 10: The method of any of aspects 1 through 9, wherein one or more uplink resources associated with the full-duplex communications do not overlap with one or more downlink resources associated with the full-duplex communications.

Aspect 11: The method of any of aspects 1 through 9, wherein one or more uplink resources associated with the full-duplex communications at least partially overlap with one or more downlink resources associated with the full-duplex communications.

Aspect 12: The method of any of aspects 1 through 11, wherein the first CSI measurement is associated with an L1 measurement.

Aspect 13: A method for wireless communication by a UE, comprising: receiving control information that comprises a configuration for a self-interference measurement, wherein the self-interference measurement is associated with full-duplex communications of the UE; performing the self-interference measurement in accordance with the configuration; and transmitting, based at least in part on the performing, a self-interference CSI report comprising one or more self-interference CSI metrics associated with the self-interference measurement.

Aspect 14: The method of aspect 13, wherein the control information does not include resources for channel measurement and does not include resources associated with interference measurements other than self-interference of the UE based at least in part on the control information being associated the self-interference measurement.

Aspect 15: The method of any of aspects 13 through 14, further comprising: receiving an indication of one or more first resources for a self-interference SRS measurement via a first field of the control information, an indication of one or more second resources for an RSSI measurement via a second field of the control information, or both, wherein the first field and the second field are associated with the configuration.

Aspect 16: The method of any of aspects 13 through 15, wherein the one or more self-interference CSI metrics are associated with an RSRP measurement for self-interference, an RSSI measurement for self-interference, an SINR measurement for self-interference, or any combination thereof.

Aspect 17: The method of any of aspects 13 through 16, further comprising: receiving, via the control information, an indication of one or more resources for a channel measurement that is associated with the self-interference measurement, wherein each resource of the one or more resources for the channel measurement is associated with at least one self-interference CSI metric.

Aspect 18: The method of any of aspects 13 through 17, wherein one or more uplink resources associated with the full-duplex communications do not overlap with one or more downlink resources associated with the full-duplex communications.

Aspect 19: The method of any of aspects 13 through 17, wherein one or more uplink resources associated with the full-duplex communications at least partially overlap with one or more downlink resources associated with the full-duplex communications.

Aspect 20: The method of any of aspects 13 through 19, wherein the self-interference measurement is associated with an L1 measurement.

Aspect 21: A method for wireless communication by a UE, comprising: receiving control information that identifies a configuration for a CSI measurement, wherein the CSI measurement is associated with measuring self-interference of the UE in one or more subbands associated with SBFD communications by the UE; performing the CSI measurement based at least in part on the configuration, wherein the CSI measurement is performed in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof; and transmitting a report of the CSI measurement based at least in part on the performing.

Aspect 22: The method of aspect 21, further comprising: receiving a time and frequency resource configuration for one or more downlink subbands of the one or more subbands and one or more uplink subbands of the one or more subbands, wherein performing the CSI measurement and transmitting the report are based at least in part on the time and frequency resource configuration.

Aspect 23: The method of any of aspects 21 through 22, further comprising: receiving a time and frequency resource configuration for one or more downlink subbands of the one or more subbands and one or more uplink subbands of the one or more subbands, wherein the CSI measurement is performed in accordance with the second measurement or in accordance with the third measurement based at least in part on the time and frequency resource configuration.

Aspect 24: The method of any of aspects 21 through 22, further comprising: receiving a time and frequency resource configuration for one or more downlink subbands of the one or more subbands and one or more uplink subbands of the one or more subbands, wherein the CSI measurement is performed in accordance with the first measurement based at least in part on the time and frequency resource configuration.

Aspect 25: The method of any of aspects 21 through 22, further comprising: receiving a time and frequency resource configuration for one or more downlink subbands of the one or more subbands and one or more uplink subbands of the one or more subbands, wherein the CSI measurement is performed in accordance with the first measurement and in accordance with the second measurement or the third measurement based at least in part on the time and frequency resource configuration.

Aspect 26: The method of any of aspects 21 through 25, further comprising: receiving, via the control information, an indication of a size for each subband to be measured of the one or more subbands, wherein performing the CSI measurement is based at least in part on the indication.

Aspect 27: The method of aspect 26, wherein the indication includes a bitmap that identifies the one or more subbands that are to be measured for self-interference via the CSI measurement.

Aspect 28: The method of aspect 21, further comprising: receiving an indication that identifies that the CSI measurement is to be performed in accordance with the first measurement, with the second measurement, or with the third measurement.

Aspect 29: The method of aspect 28, wherein the indication is received via a MAC-CE message, a DCI message, an RRC message, or any combination thereof.

Aspect 30: The method of any of aspects 21 through 29, further comprising: transmitting a second report of second CSI measurement, wherein the report is associated with the first measurement and the second report is associated with the second measurement or the third measurement.

Aspect 31: The method of any of aspects 21 through 30, wherein a self-interference metric associated with the CSI measurement is based at least in part on a type of CSI measurement.

Aspect 32: The method of any of aspects 21 through 31, further comprising: receiving, via the control information, an indication of respective self-interference metrics that are associated with each of the one or more subbands, wherein transmitting the report is based at least in part on the indication.

Aspect 33: The method of any of aspects 21 through 32, further comprising: receiving, via the control information, an indication of a first subband reporting configuration associated with a PMI measurement, a CQI measurement, or both, wherein a second subband reporting configuration for transmitting the report is a same subband reporting configuration as the first subband reporting configuration.

Aspect 34: The method of any of aspects 21 through 32, further comprising: receiving, via the control information, an indication of a first subband reporting configuration associated with a PMI measurement, a CQI measurement, or both; and modifying the first subband reporting configuration to obtain a second subband reporting configuration for transmitting the report.

Aspect 35: The method of any of aspects 21 through 34, further comprising: receiving, via a field of the control information, an indication of a subband measurement reporting configuration for transmitting the report, wherein the subband measurement reporting configuration identifies one or more measurement subbands for performing the CSI measurement.

Aspect 36: The method of any of aspects 21 through 35, wherein the CSI measurement is associated with an L1 measurement, an L3 measurement, or both.

Aspect 37: A method for wireless communication by a network entity, comprising: transmitting control information that comprises a first configuration for a first CSI measurement and a second configuration for a second CSI measurement, wherein the first CSI measurement is associated with self-interference from full-duplex communications of a UE and the second CSI measurement is associated with a channel measurement and interference measurements other than self-interference of the UE; receiving, based at least in part on transmitting the control information, a CSI report comprising one or more first CSI metrics, wherein each CSI metric of the one or more first CSI metrics is associated with both of the first CSI measurement and the second CSI measurement.

Aspect 38: The method of aspect 37, further comprising: transmitting an indication of one or more resources for the first CSI measurement via a field of the control information that is associated with self-interference.

Aspect 39: The method of aspect 37, further comprising: transmitting an indication of one or more first resources for a SRS measurement via a first field of the control information, an indication of one or more second resources for an RSSI measurement via a second field of the control information, or both, wherein the first field and the second field are associated with the first configuration.

Aspect 40: The method of any of aspects 37 through 39, wherein the one or more first CSI metrics are associated with self-interference, a channel measurement, and one or more of inter-cell interference, MU-MIMO interference, and CLI.

Aspect 41: The method of any of aspects 37 through 40, wherein the one or more first CSI metrics are associated with an identifier that indicates that the one or more first CSI metrics are associated with self-interference.

Aspect 42: The method of any of aspects 37 through 41, further comprising: receiving a second CSI report that is not associated with self-interference measurements of the UE.

Aspect 43: The method of aspect 42, further comprising: transmitting second control information that is not associated with self-interference measurements of the UE, wherein transmitting the second CSI report is based at least in part on receiving the second control information.

Aspect 44: The method of any of aspects 42 through 43, further comprising: transmitting an indication via a DCI message, a MAC-CE message, an RRC message, a field of the control information, or any combination thereof, of whether the UE is to transmit the CSI report or transmit both the CSI report and the second CSI report, wherein receiving the second CSI report is based at least in part on the indication.

Aspect 45: The method of any of aspects 37 through 44, further comprising: receiving, via the CSI report, one or more second CSI metrics different from the one or more first CSI metrics, wherein the one or more second CSI metrics are associated with interference measurements other than self-interference measurements.

Aspect 46: The method of any of aspects 37 through 45, wherein one or more uplink resources associated with the full-duplex communications do not overlap with one or more downlink resources associated with the full-duplex communications.

Aspect 47: The method of any of aspects 37 through 45, wherein one or more uplink resources associated with the full-duplex communications at least partially overlap with one or more downlink resources associated with the full-duplex communications.

Aspect 48: The method of any of aspects 37 through 47, wherein the first CSI measurement is associated with an L1 measurement.

Aspect 49: A method for wireless communication by a network entity, comprising: transmitting control information that comprises a configuration for a self-interference measurement, wherein the self-interference measurement is associated with full-duplex communications of a UE; receiving, based at least in part on transmitting the control information, a self-interference CSI report comprising one or more self-interference CSI metrics associated with the self-interference measurement.

Aspect 50: The method of aspect 49, wherein the control information does not include resources for channel measurement and does not include resources associated with interference measurements other than self-interference of the UE based at least in part on the control information being associated the self-interference measurement.

Aspect 51: The method of any of aspects 49 through 50, further comprising: transmitting an indication of one or more first resources for a self-interference SRS measurement via a first field of the control information, an indication of one or more second resources for an RSSI measurement via a second field of the control information, or both, wherein the first field and the second field are associated with the configuration.

Aspect 52: The method of any of aspects 49 through 51, wherein the one or more self-interference CSI metrics are associated with an RSRP measurement for self-interference, an RSSI measurement for self-interference, an SINR measurement for self-interference, or any combination thereof.

Aspect 53: The method of any of aspects 49 through 52, further comprising: transmitting, via the control information, an indication of one or more resources for a channel measurement that is associated with the self-interference measurement, wherein each resource of the one or more resources for the channel measurement is associated with at least one self-interference CSI metric.

Aspect 54: The method of any of aspects 49 through 53, wherein one or more uplink resources associated with the full-duplex communications do not overlap with one or more downlink resources associated with the full-duplex communications.

Aspect 55: The method of any of aspects 49 through 53, wherein one or more uplink resources associated with the full-duplex communications at least partially overlap with one or more downlink resources associated with the full-duplex communications.

Aspect 56: The method of any of aspects 49 through 55, wherein the self-interference measurement is associated with an L1 measurement.

Aspect 57: A method for wireless communication by a network entity, comprising: transmitting control information that identifies a configuration for a CSI measurement, wherein the CSI measurement is associated with measuring self-interference of a UE in one or more subbands associated with SBFD communications by the UE; receiving a report of the CSI measurement based at least in part on transmitting the control information, wherein the CSI measurement is performed by the UE in accordance with a first measurement of a first metric within at least one downlink subband of the one or more subbands, a second measurement of a second metric within at least one uplink subband of the one or more subbands, a third measurement of the first metric within the at least one uplink subband of the one or more subbands, or any combination thereof.

Aspect 58: The method of aspect 57, further comprising: transmitting a time and frequency resource configuration for one or more downlink subbands of the one or more subbands and one or more uplink subbands of the one or more subbands, wherein receiving the report is based at least in part on the time and frequency resource configuration.

Aspect 59: The method of any of aspects 57 through 58, further comprising: transmitting a time and frequency resource configuration for one or more downlink subbands of the one or more subbands and one or more uplink subbands of the one or more subbands, wherein the CSI measurement is performed by the UE in accordance with the second measurement or in accordance with the third measurement based at least in part on the time and frequency resource configuration.

Aspect 60: The method of any of aspects 57 through 58, further comprising: transmitting a time and frequency resource configuration for one or more downlink subbands of the one or more subbands and one or more uplink subbands of the one or more subbands, wherein the CSI measurement is performed by the UE in accordance with the first measurement based at least in part on the time and frequency resource configuration.

Aspect 61: The method of any of aspects 57 through 58, further comprising: transmitting a time and frequency resource configuration for one or more downlink subbands of the one or more subbands and one or more uplink subbands of the one or more subbands, wherein the CSI measurement is performed by the UE in accordance with the first measurement and in accordance with the second measurement or the third measurement based at least in part on the time and frequency resource configuration.

Aspect 62: The method of any of aspects 57 through 61, further comprising: transmitting, via the control information, an indication of a size for each subband to be measured of the one or more subbands, wherein receiving the report is based at least in part on transmitting the indication.

Aspect 63: The method of aspect 62, wherein the indication includes a bitmap that identifies the one or more subbands that are to be measured for self-interference via the CSI measurement.

Aspect 64: The method of aspect 57, further comprising: transmitting an indication that identifies that the CSI measurement is to be performed in accordance with the first measurement, with the second measurement, or with the third measurement.

Aspect 65: The method of aspect 64, wherein the indication is received via a MAC-CE message, a DCI message, an RRC message, or any combination thereof.

Aspect 66: The method of any of aspects 57 through 65, further comprising: receiving a second report of second CSI measurement, wherein the report is associated with the first measurement and the second report is associated with the second measurement or the third measurement.

Aspect 67: The method of any of aspects 57 through 66, wherein a self-interference metric associated with the CSI measurement is based at least in part on a type of CSI measurement.

Aspect 68: The method of any of aspects 57 through 67, further comprising: transmitting, via the control information, an indication of respective self-interference metrics that are associated with each of the one or more subbands, wherein receiving the report is based at least in part on the indication.

Aspect 69: The method of any of aspects 57 through 68, further comprising: transmitting, via the control information, a first subband reporting configuration associated with a PMI measurement, a CQI measurement, or both, wherein a second subband reporting configuration for transmitting the report is a same subband reporting configuration as the first subband reporting configuration.

Aspect 70: The method of any of aspects 57 through 68, further comprising: transmitting, an indication of a first subband reporting configuration associated with a PMI measurement, a CQI measurement, or both, wherein the report is received in accordance with a second subband reporting configuration based at least in part on transmitting the indication, and wherein the second subband reporting configuration is a modified version of the first subband reporting configuration.

Aspect 71: The method of any of aspects 57 through 70, further comprising: transmitting, via a field of the control information, an indication of a subband measurement reporting configuration for transmitting the report, wherein the subband measurement reporting configuration identifies one or more measurement subbands for performing the CSI measurement.

Aspect 72: The method of any of aspects 57 through 71, wherein the CSI measurement is associated with an L1 measurement, an L3 measurement, or both.

Aspect 73: A UE for wireless communication, comprising one or more memories storing processor-executable code, and one or more processors coupled with the one or more memories and individually or collectively operable to execute the code to cause the UE to perform a method of any of aspects 1 through 12.

Aspect 74: A UE for wireless communication, comprising at least one means for performing a method of any of aspects 1 through 12.

Aspect 75: A non-transitory computer-readable medium storing code for wireless communication, the code comprising instructions executable by a processor to perform a method of any of aspects 1 through 12.

Aspect 76: A UE for wireless communication, comprising one or more memories storing processor-executable code, and one or more processors coupled with the one or more memories and individually or collectively operable to execute the code to cause the UE to perform a method of any of aspects 13 through 20.

Aspect 77: A UE for wireless communication, comprising at least one means for performing a method of any of aspects 13 through 20.

Aspect 78: A non-transitory computer-readable medium storing code for wireless communication, the code comprising instructions executable by a processor to perform a method of any of aspects 13 through 20.

Aspect 79: A UE for wireless communication, comprising one or more memories storing processor-executable code, and one or more processors coupled with the one or more memories and individually or collectively operable to execute the code to cause the UE to perform a method of any of aspects 21 through 36.

Aspect 80: A UE for wireless communication, comprising at least one means for performing a method of any of aspects 21 through 36.

Aspect 81: A non-transitory computer-readable medium storing code for wireless communication, the code comprising instructions executable by a processor to perform a method of any of aspects 21 through 36.

Aspect 82: A network entity for wireless communication, comprising one or more memories storing processor-executable code, and one or more processors coupled with the one or more memories and individually or collectively operable to execute the code to cause the network entity to perform a method of any of aspects 37 through 48.

Aspect 83: A network entity for wireless communication, comprising at least one means for performing a method of any of aspects 37 through 48.

Aspect 84: A non-transitory computer-readable medium storing code for wireless communication, the code comprising instructions executable by a processor to perform a method of any of aspects 37 through 48.

Aspect 85: A network entity for wireless communication, comprising one or more memories storing processor-executable code, and one or more processors coupled with the one or more memories and individually or collectively operable to execute the code to cause the network entity to perform a method of any of aspects 49 through 56.

Aspect 86: A network entity for wireless communication, comprising at least one means for performing a method of any of aspects 49 through 56.

Aspect 87: A non-transitory computer-readable medium storing code for wireless communication, the code comprising instructions executable by a processor to perform a method of any of aspects 49 through 56.

Aspect 88: A network entity for wireless communication, comprising one or more memories storing processor-executable code, and one or more processors coupled with the one or more memories and individually or collectively operable to execute the code to cause the network entity to perform a method of any of aspects 57 through 72.

Aspect 89: A network entity for wireless communication, comprising at least one means for performing a method of any of aspects 57 through 72.

Aspect 90: A non-transitory computer-readable medium storing code for wireless communication, the code comprising instructions executable by a processor to perform a method of any of aspects 57 through 72.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control information that comprises a first configuration for a first channel state information measurement and a second configuration for a second channel state information measurement, wherein the first channel state information measurement is associated with self-interference from full-duplex communications of the UE and the second channel state information measurement is associated with a channel measurement and interference measurements other than self-interference of the UE;
perform the first channel state information measurement and the second channel state information measurement, wherein the first channel state information measurement is performed in accordance with the first configuration and the second channel state information measurement is performed in accordance with the second configuration; and
transmit, based at least in part on the performing, a channel state information report comprising one or more first channel state information metrics, wherein each channel state information metric of the one or more first channel state information metrics is associated with both of the first channel state information measurement and the second channel state information measurement.

2. The UE of claim 1, wherein the one or more processors are individually or collectively further operable to execute the code to cause the UE to:
receive an indication of one or more resources for the first channel state information measurement via a field of the control information that is associated with self-interference.

3. The UE of claim 1, wherein the one or more processors are individually or collectively further operable to execute the code to cause the UE to:
receive an indication of one or more first resources for a sounding reference signal measurement via a first field of the control information, an indication of one or more second resources for a received signal strength indicator (RSSI) measurement via a second field of the control information, or both, wherein the first field and the second field are associated with the first configuration.

4. The UE of claim 1, wherein the one or more first channel state information metrics are associated with self-interference, a channel measurement, and one or more of inter-cell interference, multiple user multiple input multiple output interference, and cross link interference.

5. The UE of claim 1, wherein the one or more first channel state information metrics are associated with an identifier that indicates that the one or more first channel state information metrics are associated with self-interference.

6. The UE of claim 1, wherein the one or more processors are individually or collectively further operable to execute the code to cause the UE to:
transmit a second channel state information report that is not associated with self-interference measurements of the UE.

7. The UE of claim 6, wherein the one or more processors are individually or collectively further operable to execute the code to cause the UE to:
receive second control information that is not associated with self-interference measurements of the UE, wherein transmitting the second channel state information report is based at least in part on receiving the second control information.

8. The UE of claim 6, wherein the one or more processors are individually or collectively further operable to execute the code to cause the UE to:
receive an indication via a downlink control information message, a medium access control-control element message, a radio resource control message, a field of the control information, or any combination thereof, of whether the UE is to transmit the channel state information report or transmit both the channel state information report and the second channel state information report, wherein transmitting the second channel state information report is based at least in part on the indication.

9. The UE of claim 1, wherein the one or more processors are individually or collectively further operable to execute the code to cause the UE to:
transmit, via the channel state information report, one or more second channel state information metrics different from the one or more first channel state information metrics, wherein the one or more second channel state information metrics are associated with interference measurements other than self-interference measurements.

10. The UE of claim 1, wherein one or more uplink resources associated with the full-duplex communications do not overlap with one or more downlink resources associated with the full-duplex communications.

11. The UE of claim 1, wherein one or more uplink resources associated with the full-duplex communications at least partially overlap with one or more downlink resources associated with the full-duplex communications.

12. The UE of claim 1, wherein the first channel state information measurement is associated with a layer one measurement.

13. A network entity, comprising:
one or more memories storing processor-executable code; and
one or more processors coupled with the one or more memories and individually or collectively operable to execute the code to cause the network entity to:
transmit control information that comprises a first configuration for a first channel state information measurement and a second configuration for a second channel state information measurement, wherein the first channel state information measurement is associated with self-interference from full-duplex communications of a UE and the second channel state information measurement is associated with a channel measurement and interference measurements other than self-interference of the UE; and
receive, based at least in part on transmitting the control information, a channel state information report comprising one or more first channel state information metrics, wherein each channel state information metric of the one or more first channel state information metrics is associated with both of the first channel state information measurement and the second channel state information measurement.

14. The network entity of claim 13, wherein the one or more processors are individually or collectively further operable to execute the code to cause the network entity to:
transmit an indication of one or more resources for the first channel state information measurement via a field of the control information that is associated with self-interference.

15. The network entity of claim 13, wherein the one or more processors are individually or collectively further operable to execute the code to cause the network entity to:
transmit an indication of one or more first resources for a sounding reference signal measurement via a first field of the control information, an indication of one or more second resources for a received signal strength indicator (RSSI) measurement via a second field of the control information, or both, wherein the first field and the second field are associated with the first configuration.

16. The network entity of claim 13, wherein the one or more first channel state information metrics are associated with self-interference, a channel measurement, and one or more of inter-cell interference, multiple user multiple input multiple output interference, and cross link interference.

17. The network entity of claim 13, wherein the one or more first channel state information metrics are associated with an identifier that indicates that the one or more first channel state information metrics are associated with self-interference.

18. The network entity of claim 13, wherein the one or more processors are individually or collectively further operable to execute the code to cause the network entity to:
receive a second channel state information report that is not associated with self-interference measurements of the UE.

19. The network entity of claim 18, wherein the one or more processors are individually or collectively further operable to execute the code to cause the network entity to:
transmit second control information that is not associated with self-interference measurements of the UE, wherein transmitting the second channel state information report is based at least in part on receiving the second control information.

20. The network entity of claim 18, wherein the one or more processors are individually or collectively further operable to execute the code to cause the network entity to:
transmit an indication via a downlink control information message, a medium access control-control element message, a radio resource control message, a field of the control information, or any combination thereof, of whether the UE is to transmit the channel state information report or transmit both the channel state information report and the second channel state information report, wherein receiving the second channel state information report is based at least in part on the indication.

21. The network entity of claim 13, wherein the one or more processors are individually or collectively further operable to execute the code to cause the network entity to:
receive, via the channel state information report, one or more second channel state information metrics different from the one or more first channel state information metrics, wherein the one or more second channel state information metrics are associated with interference measurements other than self-interference measurements.

22. The network entity of claim 13, wherein one or more uplink resources associated with the full-duplex communications do not overlap with one or more downlink resources associated with the full-duplex communications.

23. The network entity of claim 13, wherein one or more uplink resources associated with the full-duplex communications at least partially overlap with one or more downlink resources associated with the full-duplex communications.

24. The network entity of claim 13, wherein the first channel state information measurement is associated with a layer one measurement.

25. A method for wireless communication by a user equipment (UE), comprising:
receiving control information that comprises a first configuration for a first channel state information measurement and a second configuration for a second channel state information measurement, wherein the first channel state information measurement is associated with self-interference from full-duplex communications of the UE and the second channel state information measurement is associated with a channel measurement and interference measurements other than self-interference of the UE;
performing the first channel state information measurement and the second channel state information measurement, wherein the first channel state information measurement is performed in accordance with the first configuration and the second channel state information measurement is performed in accordance with the second configuration; and
transmitting, based at least in part on the performing, a channel state information report comprising one or more first channel state information metrics, wherein each channel state information metric of the one or more first channel state information metrics is associated with both of the first channel state information measurement and the second channel state information measurement.

26. The method of claim 25, further comprising:
receiving an indication of one or more resources for the first channel state information measurement via a field of the control information that is associated with self-interference.

27. The method of claim 25, further comprising:
receiving an indication of one or more first resources for a sounding reference signal measurement via a first field of the control information, an indication of one or more second resources for a received signal strength indicator (RSSI) measurement via a second field of the control information, or both, wherein the first field and the second field are associated with the first configuration.

28. A method for wireless communication by a network entity, comprising:
transmitting control information that comprises a first configuration for a first channel state information measurement and a second configuration for a second channel state information measurement, wherein the first channel state information measurement is associated with self-interference from full-duplex communications of a UE and the second channel state information measurement is associated with a channel measurement and interference measurements other than self-interference of the UE; and
receiving, based at least in part on transmitting the control information, a channel state information report comprising one or more first channel state information metrics, wherein each channel state information metric of the one or more first channel state information metrics is associated with both of the first channel state information measurement and the second channel state information measurement.

29. The method of claim 28, further comprising:
transmitting an indication of one or more resources for the first channel state information measurement via a field of the control information that is associated with self-interference.

30. The method of claim 28, further comprising:
transmitting an indication of one or more first resources for a sounding reference signal measurement via a first field of the control information, an indication of one or more second resources for a received signal strength indicator (RSSI) measurement via a second field of the control information, or both, wherein the first field and the second field are associated with the first configuration.
